(19) United States
(12) Patent Application Publication
(10) Pub. No.: US 2026/0111100 A1
(43) Pub. Date: Apr. 23, 2026

(54) METHOD AND SYSTEM FOR CONTROLLING A BATHING UNIT SYSTEM WITH TWO OR MORE SEATING AREAS

(71) Applicant: GECKO ALLIANCE GROUP INC., Québec (CA)

(72) Inventors: Dannik Gagnon, Trois-Rivières (CA); Guillaume Sénéchal, Lévis (CA); Guillaume Tremblay, Québec (CA); Dominic Gosselin, Sainte-Catherine-De-Hatley (CA); Benoit Laflamme, Québec (CA)

(21) Appl. No.: 19/168,381

(22) PCT Filed: Mar. 28, 2024
(86) PCT No.: PCT/CA2024/050408

§ 371 Date: Sep. 24, 2025

Related U.S. Application Data
(60) Provisional application No. 63/587,307, filed on Oct. 2, 2023.

(51) Int. Cl. G06F 3/0484; A61H 33/00; A61H 33/06; G05B 15/02; G06F 3/01; G06F 3/0482; G06F 3/0487

(52) U.S. Cl. CPC G06F 3/0484; A61H 33/067; G05B 15/02; G06F 3/0482; G06F 3/0487; A61H 2033/0079; A61H 2201/5046; G06F 3/011

(57) ABSTRACT

A system for controlling a bathing unit system including a receptacle with two or more seating areas and a plurality of bathing unit components is disclosed. The system comprises a) a user interface presenting user selectable options allowing a user to independently select a specific seating area of the two or more seating areas. The system further comprises b) at least one processor in communication with the user interface and configured to, in response to a user selection of a first seating area, control at least one of: operational settings of a first set of the plurality of bathing unit components, the first set of the plurality of bathing unit components being mapped to the first seating area; and a specific spa experience in connection with the first seating area at least in part by controlling the first set of the plurality of bathing unit components.

### CROSS-REFERENCE TO RELATED APPLICATION

For the purpose of the United States, this application claimed of benefit of priority under 35 U.S.C. 119(e) based on provisional application No. 63/587,307 filed Oct. 2, 2023 entitled “CONTROL PANEL FOR BATHING UNIT SYSTEM WITH TWO OR MORE DISTINCT SEATING AREAS AND METHOD OF USING SAME”, the content of which is incorporated by reference herein in its entirety.

### TECHNICAL FIELD

The present invention relates generally to the field of bathing unit systems, and more specifically, to system and method for controlling a bathing unit system including a receptacle with two or more seating areas and a plurality of bathing unit components.

### BACKGROUND

A bathing unit system, such as spas/swim-spas, whirlpools, hot tubs, bath tubs, therapeutic baths and swimming pools, typically include a receptacle holding water and a circulation system comprising a plurality of conduits. The such bathing unit systems further include various bathing unit components for controlling and otherwise regulating the water circulating through the circulation system, including one or more pumps to circulate water in the circulation system, one or more temperature change modules (e.g., heaters to heat the water and coolers to cool the water), one or more diverter components (e.g., a diverter valve) to direct flow of the water, one or more air blowers, a filter system to filter the water, one or more lights for generating lighting in the receptacle or around the bathing unit system, one or more speakers for projecting music or other audio data around the bathing unit system, one or more video displays for displaying video or other visual data to users using the bathing unit system. Such bathing unit systems also further include a controller for activating, deactivating and controlling operation of these various bathing unit components.

Most modern bathing unit systems also include a control panel that is in communication with the controller. This control panel may be a topside control panel generally coupled or attached to the receptacle. This control panel may also be a control panel implemented on a user device such as a smart phone or a tablet or other personal computing device. A user of the bathing unit system can use the control panel to activate, deactivate and control operation of the various bathing unit components. The controller and the control panel may form the control system of a particular bathing unit system.

However, a deficiency with conventional control systems of bathing unit systems is that such conventional control systems do not allow a user to control operational settings of bathing unit components in a seating area specific manner, for example, to control operational settings of specific bathing unit components which are directed to a specific seating area the user may be occupying. In particular, conventional control systems are ill suited for facilitating personalized/individualized control of bathing unit systems with several seating areas, such as two, three, four, five, six or more seating areas, in which different users can settle into to relax enjoy a spa experience and in which such different users may prefer different spa experiences or different operational settings.

It is known in the art to have control systems that provide functionality allowing a user to selectively activate, deactivate or control operation of different pumps of the bathing unit system so that corresponding jets located in different areas of the receptacle may be separately activated or deactivated. However, even with existing control systems having such functionality, determining which pump corresponds to which jets in a specific seating area is often the result of trial and error by the user, and may also require further manual adjustment of a diverter component by the user. This issue is particularly relevant for a user that is using a bathing unit system for the first time and who would not know what pump and/or diverter component operational settings would be appropriate for a given seating area. In addition, even when a bathing unit system has been used several times, it is to be appreciated that users may not have spatial awareness of where they are in the receptacle relative to specific bathing unit components (e.g., a specific pump) while they are within the receptacle. In such a situation, the user may use the control system to turn “on” and “off” different pumps until the jets corresponding to their occupied seating area are activated. The user may then manually adjust a diverter component or the jets to achieve a desired effect at their occupied seating area. While this approach provides a user with the ability to achieve a desired effect for a specific seat, the process is piecemeal and is far from being smooth.

Additionally, outside of providing functionality allowing a user to selectively activate, deactivate or control operation of different pumps in the bathing unit system, existing conventional control system fail to provide functionality allowing a user to selectively activate, deactivate or control operation of other bathing unit components of the bathing unit system which are directed to a specific seating area in the receptacle.

Another deficiency of conventional control systems is that they fail to provide functionality allowing different users using the bathing unit system at the same time (but sitting in different seating areas of the receptacle) to conveniently customize their individual spa experience without significantly affecting the spa experience of another user.

Against the background described above, there is a need in the industry to provide a control system that facilitates the activation, deactivation and control of the operational settings of bathing unit components in a manner that alleviates at least in part the problems associated with existing control systems.

### SUMMARY

A problem sought to be addressed is to provide a control system that facilitates personalized/individualized control of different bathing unit components of a bathing unit system including two or more seating areas in a receptacle. To solve this above problem, various embodiments described herein include a control system having a user interface which allows a user to select a particular seating area from the two or more seating areas in the receptacle, and then only control, or only present user selectable options for controlling, a set of bathing unit components which are mapped to the selected seating area. The set of bathing unit components may be mapped to a selected seating area by a manufacturer of the bathing unit system and may also alternatively be mapped to a selected seating area by a user of the bathing unit system.

Different combination of features below can provide a control system that allows a user to control bathing unit components on a seating area basis: (a) a user interface which allows a user to select a seating area from the two or more seating areas, (b) a set of bathing unit components which are mapped to each seating area of the two or more seating areas, and (c) in response to a user selecting a seating area of the two or more seating areas, (i) controlling operational settings of the set of bathing unit components mapped to that selected seating area and/or a spa experience at that selected seating area or (ii) adapting the user interface to allow control of the operational settings of the set of bathing unit components mapped to that selected seating area and/or the spa experience at that selected seating area,. This can allow a user to easily and intuitively control the bathing unit components which are most relevant for that user and which affect a seating area occupied by that user. This can also allow different users occupying different seating areas to independently control bathing unit components which affect their seating area, without significantly affecting another user occupying another seating area, thus allowing different users to enjoy their individual preferred spa experience in a bathing unit system at a same time.

In one embodiment, there is provided a system for controlling a bathing unit system including a receptacle with two or more seating areas and a plurality of bathing unit components. The system comprises a) a user interface presenting user selectable options allowing a user to independently select a specific seating area of the two or more seating areas. The system further comprises b) at least one processor in communication with the user interface and configured to i) in response to a user selection of a first seating area of the two or more seating areas, control at least one of: A. operational settings of a first set of the plurality of bathing unit components, the first set of the plurality of bathing unit components being mapped to the first seating area; and B. a specific spa experience in connection with the first seating area at least in part by controlling the first set of the plurality of bathing unit components.

In response to the user selection of the first seating area, said at least one processor may be further configured to: a) access a computer readable memory storing seating area specific information, said seating area specific information mapping each of the two or more seating areas in the receptacle to respective sets of bathing unit components in the plurality of bathing unit components; and b) process the seating area specific information and the first seating area to derive the first set of the plurality of bathing unit components mapped to the first seating area.

The system may further comprise the computer readable memory storing seating area specific information, said computer readable memory being in communication with said at least one processor.

The at least one processor may be in communication with the computer readable memory over a data network.

The system may further comprise a display screen, wherein the user interface may comprise a graphical user interface (GUI) displayed on the display screen.

The at least one processor may be configured to generate the GUI to present the user selectable options as at least one of: a) user selectable portions of a visual depiction of the receptacle showing each seating area of the two or more seating areas spatially oriented relative to other seating areas of the two or more seating areas; and b) user selectable icons corresponding to respective seating areas of the two or more seating areas.

The user interface may comprise two or more physical buttons corresponding to the user selectable options.

The user interface may further comprise a visual depiction of the receptacle showing each seating area of the two or more seating areas spatially oriented relative to other seating areas of the two or more seating areas.

The at least one processor may be further configured to, in response to the user selection of the first seating area, adapt the GUI to present a first set of user selectable options customized to the first seating area, the first set of user selectable options selectable by the user to generate command signals for controlling at least one of: a) the operational settings of the first set of the plurality of bathing unit components; and b) the specific spa experience in connection with the first seating area.

The at least one processor may be further configured to, in response to a user selection of a second seating area of the two or more seating areas, adapt the GUI to present a second set of user selectable options customized to the second seating area, the second set of user selectable options selectable by the user to generate command signals for controlling at least one of: a) operational settings of a second set of the plurality of bathing unit components, the second set of the plurality of bathing unit components being mapped to the second seating area; and b) a specific spa experience in connection with the second seating area at least in part by controlling the second set of the plurality of bathing unit components.

The first set of user selectable options and the second set of user selectable options may be different.

The at least one processor may be further configured to, in response to a user selection of a second seating area of the two or more seating areas, control at least one of: a) operational settings of a second set of the plurality of bathing unit components, the second set of the plurality of bathing unit components being mapped to the second seating area; and b) a specific spa experience in connection with the second seating area at least in part by controlling the second set of the plurality of bathing unit components.

The at least one processor may be further configured to, after controlling the first set of the plurality of bathing unit components, control at least one of: a) operational settings for a second set of the plurality of bathing unit components, the second set of the plurality of bathing unit components being mapped to a second seating area of the two or more seating areas; and b) a specific spa experience in connection with the second seating area at least in part by controlling the second set of the plurality of bathing unit components.

The at least one processor may be further configured to, concurrently with controlling the first set of the plurality of bathing unit components, control at least one of: a) operational settings for a second set of the plurality of bathing unit components, the second set of the plurality of bathing unit components being mapped to a second seating area of the two or more seating areas; and b) a specific spa experience in connection with the second seating area at least in part by controlling the second set of the plurality of bathing unit components.

The first set of the plurality of bathing unit components and the second set of the plurality of bathing unit components may include at least one common bathing unit component.

The operational settings for the first set of the plurality of bathing unit components may direct operation of the at least one common bathing unit component towards the first seating area. The operational settings for the second set of the plurality of bathing unit components may direct the operation of the at least one common bathing unit component towards the second seating area.

The at least one common bathing unit component may include a pump.

The first set of the plurality of bathing unit components may comprise at least one bathing unit component that is absent from the second set of the plurality of bathing unit components.

The at least one processor may be further configured to: a) receive a user identification signal conveying user identification information corresponding to the user providing the user selection; and b) retrieve user preference information from a memory in communication with the at least one processor at least in part by processing the user identification information, wherein the at least one processor is configured to control the first set of the plurality of bathing unit components at least in part by processing the retrieved user preference information.

The at least one processor may be further configured to receive a user input signal conveying the user selection of the first seating area.

The user input signal conveying the user selection of the first seating area may comprise at least one of: a) an input signal generated by the user interface in response to the user selecting the first seating area using the user selectable options presented by the user interface; b) an input signal generated by a presence sensor conveying that the user is occupying the first seating area in the receptacle; and c) an input signal generated by a sensor detecting a user interaction selecting the first seating area.

The sensor detecting the user interaction may comprise at least one microphone and the user interaction comprises a voice command conveying the first seating area. The sensor detecting the user interaction may comprise at least one camera and the user interaction comprises a movement command conveying the first seating area.

The at least one processor may be embodied in at least one of a control panel and a controller.

The control panel may comprise at least one of a topside control panel and a personal communication device.

The personal communication device may be at least one of a smart phone, a wearable device, a tablet and a personal computer.

The controller may comprise at least one of a local bathing unit controller and a remote server.

The set of the plurality of bathing unit components may comprise at least one bathing unit component of the plurality of bathing unit components.

The first set of the plurality of bathing unit components may comprise at least two bathing unit components of the plurality of bathing unit components.

In another embodiment, there is provided a computer-implemented method for controlling a bathing unit system including a receptacle with two or more seating areas, a plurality of bathing unit components and a user interface presenting user selectable options allowing a user to independently select a specific seating area of the two or more seating areas. The computer-implemented method comprises a) in response to a user selection of a first seating area of the two or more seating areas, controlling at least one of: i) operational settings of a first set of the plurality of bathing unit components, the first set of the plurality of bathing unit components being mapped to the first seating area; and ii) a specific spa experience in connection with the first seating area at least in part by controlling the operational settings of the first set of the plurality of bathing unit components.

The computer-implemented method may further comprise, in response to the user selection of the first seating area: a) accessing a computer readable memory storing seating area specific information, said seating area specific information mapping each of the two or more seating areas in the receptacle to respective sets of bathing unit components in the plurality of bathing unit components; and b) processing the seating area specific information and the first seating area to derive the first set of the plurality of bathing unit components mapped to the first seating area.

The user interface may comprise a graphical user interface (GUI) presented on a display screen. The GUI may present the user selectable options as at least one of: a) user selectable portions of a visual depiction of the receptacle showing each seating area of the two or more seating areas spatially oriented relative to other seating areas of the two or more seating areas; and b) user selectable icons corresponding to respective seating areas of the two or more seating areas.

The user interface may comprise two or more physical buttons corresponding to the user selectable options.

The computer-implemented method may further comprise, in response to the user selection of the first seating area, adapting the GUI to present a first set of user selectable options customized to the first seating area, the first set of user selectable options selectable by the user to generate command signals for controlling at least one of: a) the operational settings of the first set of the plurality of bathing unit components; and b) the specific spa experience in connection with the first seating area.

The computer-implemented method may further comprise, in response to a user selection of a second seating area of the two or more seating areas, adapting the GUI to present a second set of user selectable options customized to the second seating area, the second set of user selectable options selectable by the user to generate command signals for controlling at least one of: a) operational settings of a second set of the plurality of bathing unit components, the second set of the plurality of bathing unit components being mapped to the second seating area; and b) a specific spa experience in connection with the second seating area at least in part by controlling the second set of the plurality of bathing unit components.

The computer-implemented method may further comprise, in response to a user selection of a second seating area of the two or more seating areas, controlling at least one of: a) operational settings of a second set of the plurality of bathing unit components, the second set of the plurality of bathing unit components being mapped to the second seating area; and b) a specific spa experience in connection with the second seating area at least in part by controlling the second set of the plurality of bathing unit components.

The computer-implemented method may further comprise, after controlling the first set of the plurality of bathing unit components, controlling at least one of: a) operational settings for a second set of the plurality of bathing unit components, the second set of the plurality of bathing unit components being mapped to a second seating area of the two or more seating areas; and b) a specific spa experience in connection with the second seating area at least in part by controlling the second set of the plurality of bathing unit components.

The computer-implemented method may further comprise, concurrently with controlling the first set of the plurality of bathing unit components, controlling at least one of: a) operational settings for a second set of the plurality of bathing unit components, the second set of the plurality of bathing unit components being mapped to a second seating area of the two or more seating areas; and b) a specific spa experience in connection with the second seating area at least in part by controlling the second set of the plurality of bathing unit components.

The first set of the plurality of bathing unit components and the second set of the plurality of bathing unit components may include at least one common bathing unit component.

The at least one common bathing unit component may include a pump.

The first set of the plurality of bathing unit components may comprise at least one bathing unit component that is absent from the second set of the plurality of bathing unit components.

The computer-implemented method may further comprise: receiving a user identification signal conveying user identification information corresponding to the user providing the user selection; and receiving user preference information at least in part by processing the user identification information, wherein controlling the operational settings of the first set of the plurality of bathing unit components comprises controlling the operational settings of the first set of the plurality of bathing unit components at least in part by processing the retrieved user preference information.

The computer-implemented method may further comprise receiving a user input signal conveying the user selection of the first seating area.

The user input signal may comprise at least one of: a) an input signal generated by the user interface in response to the user selecting the first seating area using the user selectable options presented by the user interface; b) an input signal generated by a presence sensor conveying that the user is occupying the first seating area in the receptacle; and c) an input signal generated by a sensor detecting a user interaction selecting the first seating area.

The first set of the plurality of bathing unit components may comprise at least one bathing unit component of the plurality of bathing unit components.

The first set of the plurality of bathing unit components may comprise at least two bathing unit components of the plurality of bathing unit components.

In another embodiment, there is provided a control panel including at least one processor and machine readable program instructions stored on a non-transient computer readable memory, said readable program instructions when executed by said at least one processor being configured to implement the computer-implemented method described above or any variants thereof. The control panel comprises at least one of a topside control panel and a personal communication device.

In another embodiment, there is provided a controller including at least one processor and machine readable program instructions stored on a non-transient computer readable memory, said readable program instructions when executed by said at least one processor being configured to implement the computer-implemented method described above or any variants thereof. The controller comprises at least one of a local controller and a remote server.

In another embodiment, there is provided a control panel for a bathing unit system including a receptacle with two or more seating areas and a plurality of bathing unit components. The control panel comprises a) a display screen. The control panel further comprises b) one or more processors in communication with the display screen, the one or more processors configured for: i) displaying a graphical user interface (GUI) on the display screen presenting user selectable options allowing a user to independently select a specific seating area of the two or more seating areas; and ii) in response to a user selection of a first seating area of the two or more seating areas, adapting the GUI to present a first set of user selectable options customized to the first seating area. The first set of user selectable options are selectable the user to generate command signals for controlling at least one of: A. operational settings of a first set of the plurality of bathing unit components, the first set of the plurality of bathing unit components being mapped to the first seating area; and B. a specific spa experience in connection with the first seating area at least in part by controlling the first set of the plurality of bathing unit components.

In another embodiment, there is provided a system for controlling a bathing unit system including a receptacle with two or more seating areas and a plurality of bathing unit components. The system comprises a) the control panel described above or any variants thereof. The system further comprises b) a bathing unit controller in communication with the control panel and comprising one or more controller processors, the one or more controller processors configured for: i) receiving the command signals from the control panel; and ii) processing the command signals and controlling at least one of: A. the operational settings of the first set of the plurality of bathing unit components based at least in part on the command signals; and B. the specific spa experience in connection with the first seating area based at least in part on the command signals.

In another embodiment, there is provided a computer-implemented method for controlling a bathing unit system including a receptacle with two or more seating areas and a plurality of bathing unit components. The computer-implemented method comprises a) causing a display screen to display a graphical user interface (GUI) presenting user selectable options allowing a user to independently select a specific seating area of the two or more seating areas. The computer-implemented method further comprises b) in response to a user selection of a first seating area of the two or more seating areas, causing the display screen to adapt the GUI to present a first set of user selectable options customized to the first seating area, the first set of user selectable options selectable by the user to generate command signals for controlling at least one of: i) operational settings of a first set of the plurality of bathing unit components, the first set of the plurality of bathing unit components being mapped to the first seating area; and ii) a specific spa experience in connection with the first seating area at least in part by controlling the first set of the plurality of bathing unit components.

In another embodiment, there is provided a control panel for a bathing unit system including a receptacle with two or more seating areas and a plurality of bathing unit components, the control panel including user selectable options selectable by a user to independently select a specific seating area of the two or more seating areas. The control panel is configured for a) in response to a user selection of a first seating area of the two or more seating areas, generating command signals for controlling at least one of: i) operational settings for a first set of the plurality of bathing unit components, the first set of the plurality of bathing unit components being mapped to the first seating area; and ii) a specific spa experience in connection with the first seating area at least in part by controlling the first set of the plurality of bathing unit components.

In another embodiment, there is provided a system for controlling a bathing unit system including a receptacle with two or more seating areas and a plurality of bathing unit components. The system comprises a) the control panel described above or any variants thereof. The system further comprises b) a controller in communication with the control panel, wherein the controller is configured for: i) receiving the command signals from the control panel; and ii) processing the command signals and controlling at least one of: A. the operational settings of the first set of the plurality of bathing unit components based at least in part on the command signals; and B. the specific spa experience in connection with the first seating area based at least in part on the command signals.

In another embodiment, there is provided a controller for controlling a bathing unit system including a receptacle with two or more seating areas, a plurality of bathing unit components and a user interface including user selectable options allowing a user to independently select a specific seating area of the two or more seating areas. The controller is configured to receive a user input signal conveying user selection of a first seating area of the two or more seating areas. The controller is further configured to a) in response to the user selection of the first seating area, control at least one of: i) operational settings of a first set of the plurality of bathing unit components, the first set of the plurality of bathing unit components being mapped to the first seating area; and ii) a specific spa experience in connection with the first seating area at least in part by controlling the operational settings of the first set of the plurality of bathing unit components.

In another embodiment, there is provided a system for controlling a bathing unit system including a receptacle with two or more seating areas and a plurality of bathing unit components. The system comprises: a) the controller described above; and b) a control panel in communication with the controller, wherein the user interface is embodied in the control panel.

All features of embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Drawings.

### BRIEF DESCRIPTION OF THE DRAWINGS

A detailed description of the embodiments of the present invention is provided herein below, by way of example only, with reference to the accompanying drawings, in which:

FIG. 1 shows a block diagram of a bathing unit system including at least one pump, at least one diverter component, at least one air blower, at least one temperature change component, and a control system comprising a controller and a control panel in accordance with one embodiment;

FIG. 2 shows a block diagram of the bathing unit system of FIG. 1 now including at least one light, at least one speaker, at least one visual display, at least one sensor and still including the control system comprising the controller and the control panel in accordance with one embodiment;

FIG. 3 is a schematic diagram of a controller of the bathing unit system of FIG. 1 in accordance with one embodiment;

FIGS. 4A-4E are schematic diagrams of, respectively, a seating area data store, a bathing unit component data store, an operational settings data store, a spa experience data store and a user preference data store stored in a storage memory of the controller of FIG. 3 in accordance with one embodiment;

FIGS. 5A-5C are schematic diagrams of mappings between entries in the seating area data store of FIG. 4A with entries in the bathing unit component data store of FIG. 4B, entries in the operational settings data store of FIG. 4C, entries in the spa experience data store of FIG. 4D and entries in the user preference data store of FIG. 4E, in accordance with one embodiment;

FIG. 6 is a schematic diagram of a remote server of the bathing unit system of FIG. 1 in accordance with one embodiment;

FIG. 7 is a schematic diagram of the control panel of the bathing unit system of FIG. 1 in accordance with one embodiment;

FIGS. 8A and 8B are user interfaces of the control panel of FIG. 7 comprising a touch/presence-sensitive assembly in accordance with two different embodiments;

FIGS. 9A-9D are user interfaces of the control panel of FIG. 7 comprising a physical actuator in accordance with four different embodiments;

FIG. 10 is a schematic diagram of a user device in communication with of the bathing unit system of FIG. 1 in accordance with one embodiment;

FIGS. 11A and 11B are user interfaces of the user device of FIG. 10 comprising a touch/presence-sensitive assembly in accordance with two different embodiments;

FIG. 12 is a flowchart of a select seating area process, control bathing unit components process, and adapt user interface process executed using at least one of the controller of FIG. 3 or the remote server of FIG. 6 or the control panel of FIG. 7 or the user device of FIG. 10 in accordance with one embodiment; and

FIGS. 13A and 13B are the user interface of FIG. 8A or FIG. 8B of the control panel of FIG. 7 displaying, respectively, a first seating area specific menu and a second seating area specific menu. In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to specific implementations and uses of embodiments of the invention in the context of bathing unit system. The phrase “bathing unit system” as used herein include without limitation spas/swim-spas, whirlpools, hot tubs, bath tubs, therapeutic baths and swimming pools and any other type of unit having a receptacle for holding water. Moreover, while specific embodiments have been described for use in the context of bathing unit systems, one skilled in the art will appreciate that, in view of the present description, alterative embodiments may be configured for use in any system including two or more seating areas in which separate control of a set of components mapped to or otherwise affecting a particular seating area of the two or more seating areas may be desired.

### Bathing Unit System 100

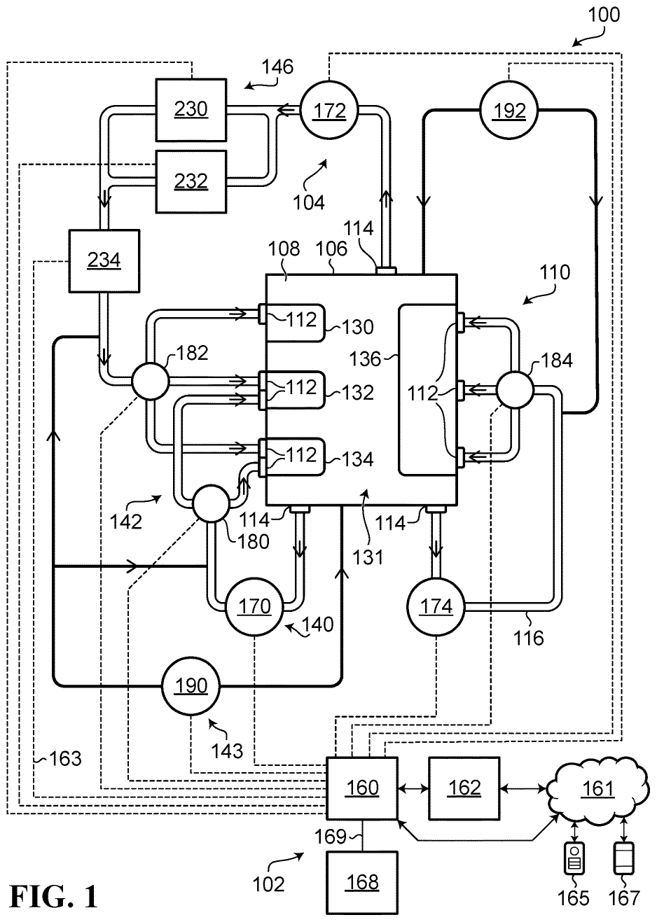

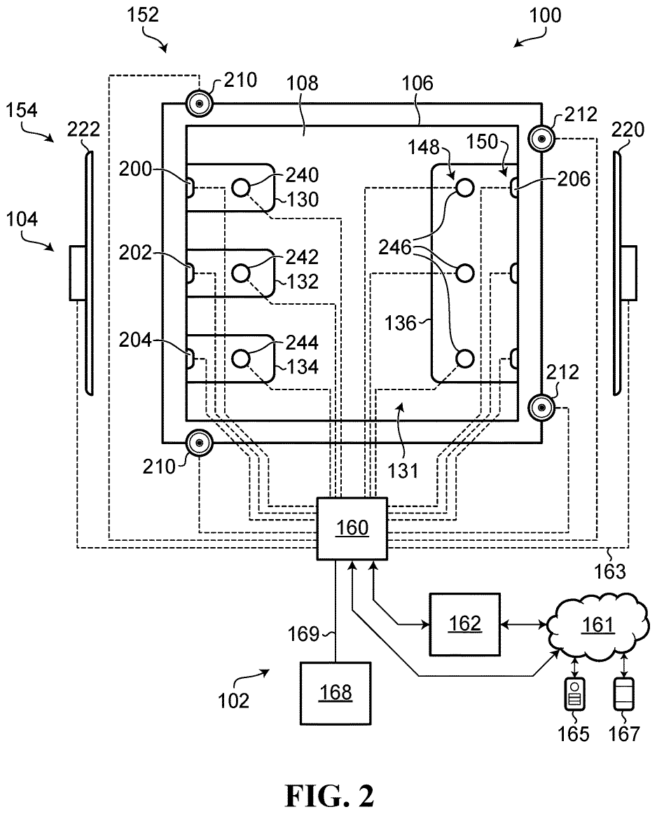

One embodiment of a bathing unit system 100 equipped with a control system 102 for controlling a set of bathing unit components 104 is shown in FIGS. 1 and 2. The phrase “set” as used herein includes (a) zero (e.g., a null set), (b) one and/or (c) more than one. For example, “a set of bathing unit components” or “a set of a plurality of bathing unit components” includes (a) no bathing unit component or (b) only one bathing unit component or (c) more than one bathing unit component. In the embodiment shown, the bathing unit system 100 includes a receptacle 106 for holding water 108. The receptacle 106 includes two or more seating areas 131 which may be occupied by one or more users. The phrase “seating areas” as used herein include, without limitation, one or more seats, one or more benches, or generally one or more areas of a receptacle 106 which may be separately occupied by different users of the bathing unit system 100. In some embodiments, particular seating area may be occupied by one user; however, in other embodiments, a particular seating area may be occupied by more than one user.

In the embodiment shown in FIGS. 1 and 2, the two or more seating areas 131 includes a first seating area 130, a second seating area 132, a third seating area 134 and a fourth seating area 136. Each seating area 130, 132, 134 and 136 may be occupied by one or more users. In the embodiment shown, the first, second and third seating areas 132, 134 and 136 are configured to be single occupancy seating areas adapted for a single user. Accordingly, in some embodiments, a set of bathing unit components mapped (described below) to the first and second seating areas 132 and 134 may be adapted for use by a single user. In contrast, the fourth seating area 136 may be configured to be a multiple occupancy seating area adapted for more than one user. In such embodiments, a set of bathing unit components mapped (described below) to the fourth seating area 136 may be adapted for use by more than one user. Moreover, while a specific embodiment of the receptacle 106 and the two or more seating areas 131 have been illustrated in FIGS. 1 and 2, one skilled in the art will appreciate that alterative embodiments may include more, fewer or alternative seating areas. As further examples, some embodiments of the receptacle 106 may include only single occupancy seating areas adapted for a single user; additionally other embodiments of the receptacle 106 may only include multiple occupancy seating areas adapted for more than one user. In yet other embodiments of the receptacle 106, the two or more seating areas 131 may instead comprise two or more swim areas, alone or in combination with seats or benches. Such swim areas may be occupied by one or more users for swimming purposes and/or training purposes rather than sitting or relaxation purposes. Such swimming areas may not include seats or benches.

The receptacle 106 further includes a plurality of water inlets 112 (eight are shown in FIG. 1, which will typically correspond to jets in the receptacle 106; as used herein “jet” and “inlet” are used interchangeably to refer to openings connecting the receptacle 106 to a circulation system 110 and from which the water 108 enters the receptacle 106, one skilled in the art will understand that depending on the configuration of the bathing unit system 100, a particular inlet may correspond to multiple jets (e.g., through a plenum), or a particular jet may receive water from multiple inlets) and a plurality of water outlets 114 (three are shown in FIG. 1). The circulation system 110 includes a plurality of conduits 116 for removing the water 108 from, and returning the water 108 to, the receptacle 106 through the inlets 112 and the outlets 114. One skilled in the art will appreciate that the bathing unit system 100 shown in FIGS. 1 and 2 is an embodiment only; practical implementations of the bathing unit system 100 may include additional or fewer inlets 112, additional or fewer outlets 114, additional or fewer conduits 116, and/or a different configuration of conduits 116 in the circulation system 110 interconnecting the inlets 112 and the outlets 114, etc.

The bathing unit system 100 also includes the bathing unit components 104 for providing different functionality (as described below). In the embodiment shown in FIGS. 1 and 2, the set of bathing unit components includes at least one pump 140, at least one diverter component 142, at least one temperature change component 146 and at least one sensor 148. Additionally, the set of bathing unit components shown in FIGS. 1 and 2 also includes some optional bathing unit components which may not be included in every bathing unit system 100, including at least one air blower 143, at least one light 150 and at least one speaker 152, and at least one visual display 154. Other embodiments of the bathing unit system 100 may not include every bathing unit component 104 described above; yet other embodiments may also include additional or alternative bathing unit components 104, such as at least one filter, at least one sanitizer dispensing component, at least one water quality monitoring component, etc.

The bathing unit system 100 also include the control system 102 in communication with the different bathing unit components 104. In the embodiment shown, the control system 102 includes a controller 160 and a control panel 162. The controller 160 may be implemented as a local controller, alone or in combination with a remote server 165. Referring to FIGS. 1 and 2, the local controller 160 may be located physically near (e.g., on or in a same room as) the bathing unit system 100. In contrast, the remote server 165 may be located physically separate (e.g., in a different building from) the bathing unit system 100. The controller 160 may generally be configured to at least (a) receive parameters from the different bathing unit components 104 as described below, (b) receive user input and user selections from a user entered via the control panel 162 to activate, deactivate and control different bathing unit components 104 as described below, and (c) to supply power from at least one power source 168 to the different bathing unit components 104 as described below.

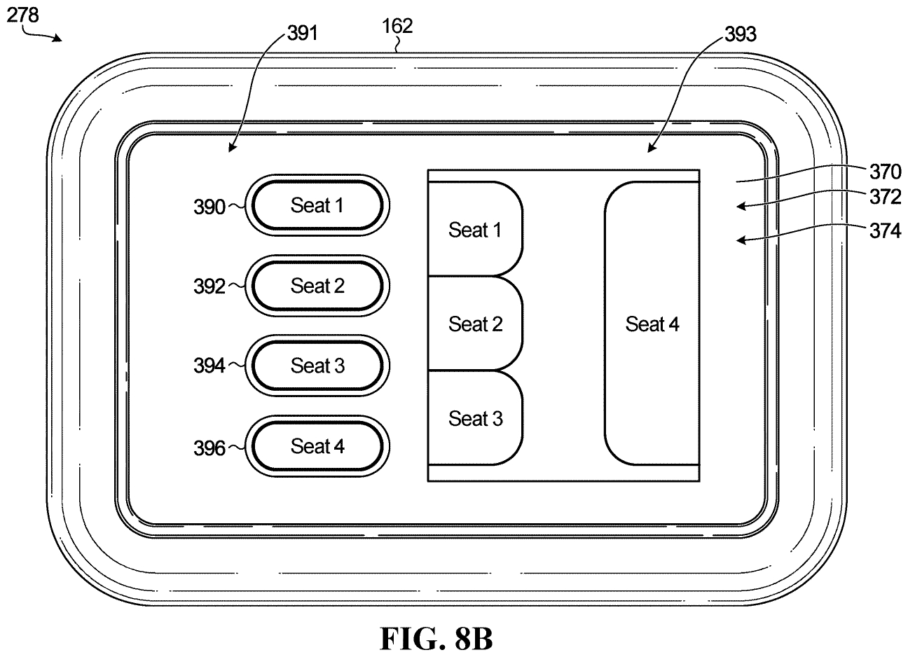

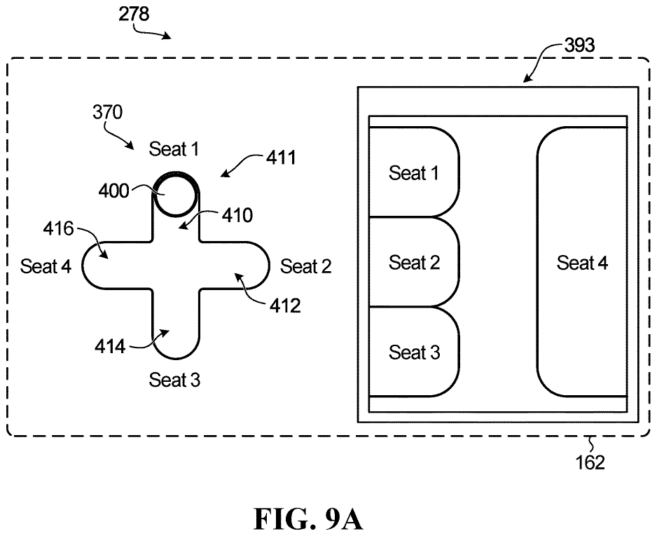

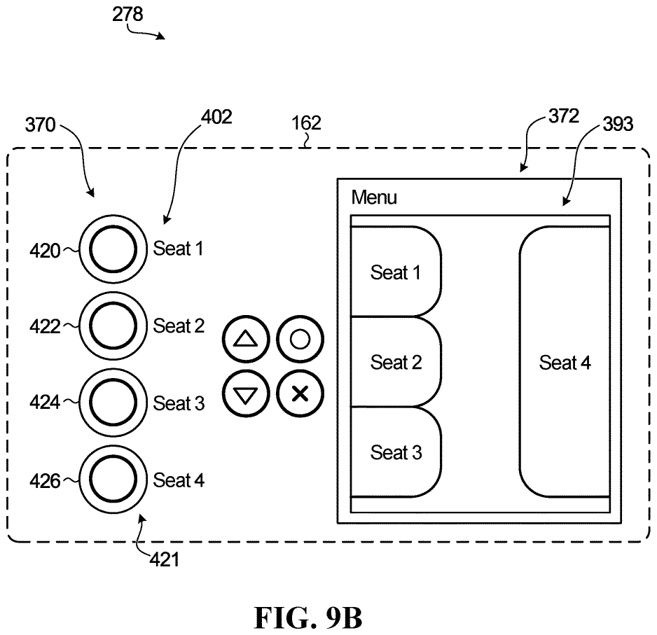

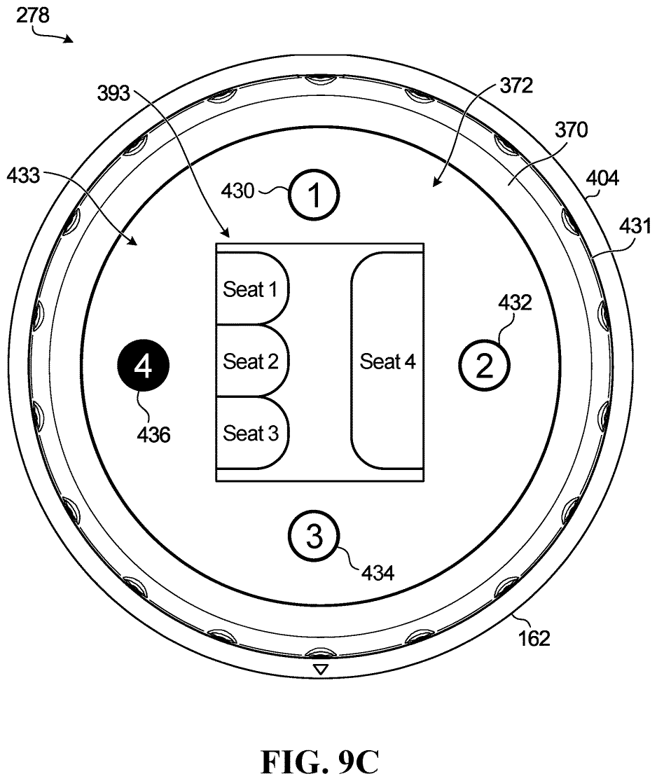

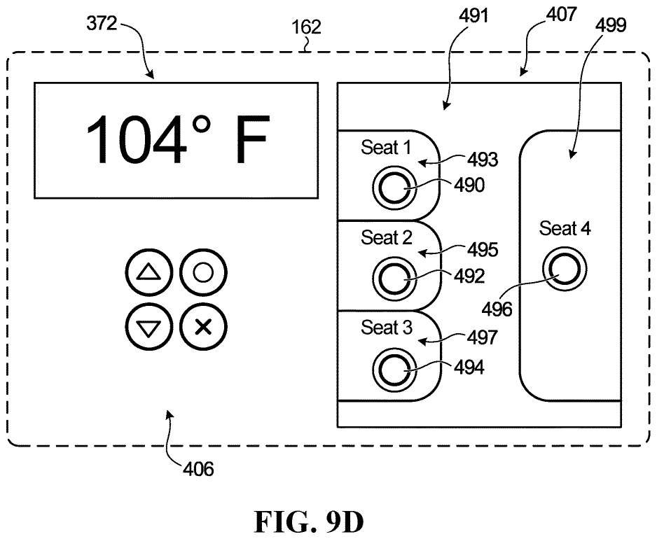

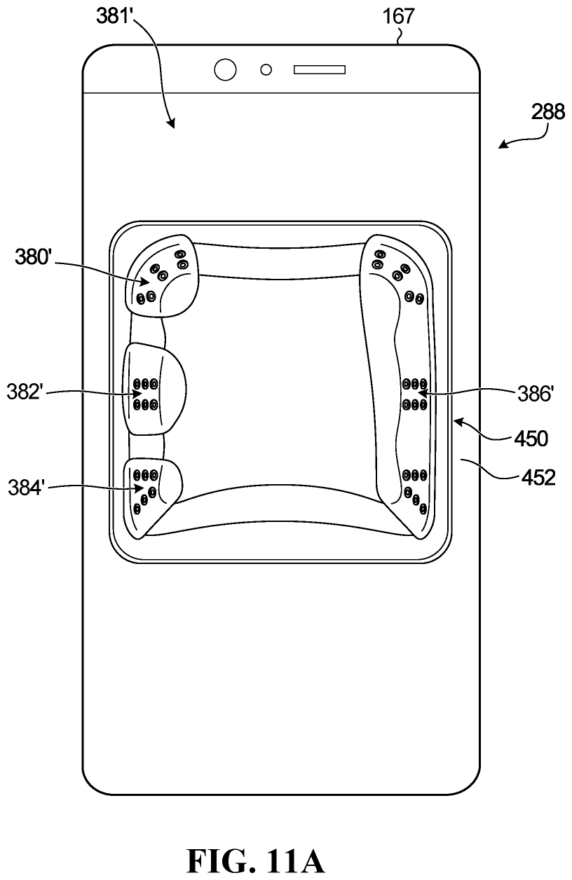

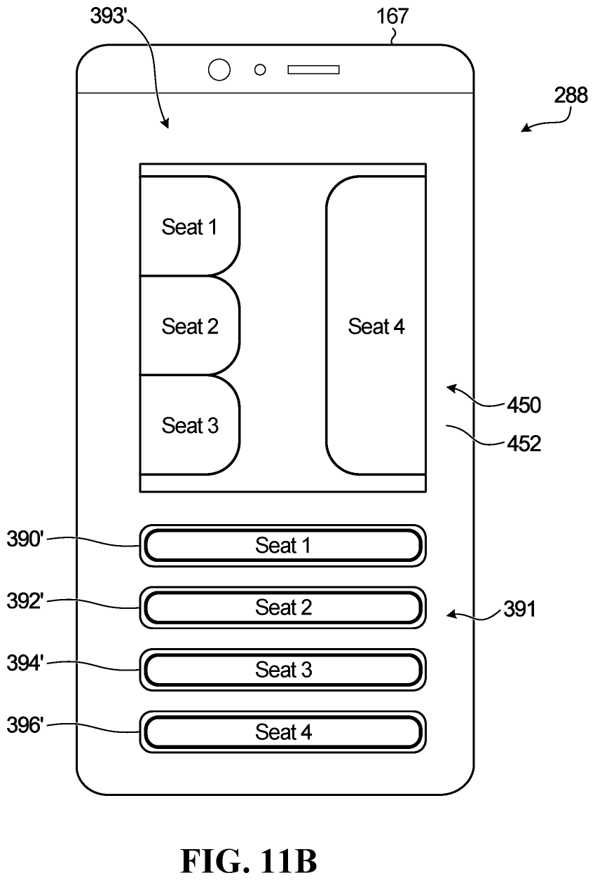

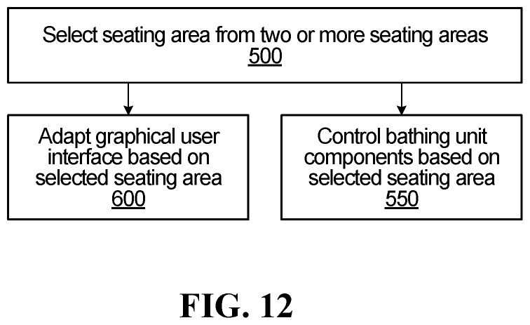

The control panel 162 provides an interface for allowing a user of the bathing unit system 100 to provide commands or other information to the controller 160 for controlling the various bathing unit components 104. The control panel 162 may also allow the user to monitor the operational status of the bathing unit components 104, as well as to monitor operational characteristics of the bathing unit system 100, such as water temperature, ambient temperature and/or water quality for example. The control panel 162 may be implemented as a top-side control panel or as a separate user device 167. Referring to FIGS. 1 and 2, the topside control panel 162 may be located physically near (e.g., on or in a same room as) the bathing unit system 100. As described below in association with FIGS. 8A-8B and 9A-9D, the topside control panel 162 may include keypads, touch screens and other physical actuators for enabling user input and user selections, alone or in combination with a display screen for displaying information regarding the different bathing unit components 104. An example of such a topside control panel include various embodiments described in the related U.S. application Ser. No. 17/515703, titled “TOPSIDE CONTROL PANEL AND TOPSIDE CONTROL PANEL SYSTEM FOR BATHING UNIT SYSTEM AND METHOD OF OPERATING THE SAME”, filed on Nov. 1, 2021 and related U.S. Pat. No. 10,353,499, titled “TOPSIDE CONTROL PANEL FOR BATHING UNIT SYSTEM”, filed on Mar. 19, 2018, the contents of which are incorporated by reference herein. In contrast, the user device 167 may be unattached and mobile relative to the bathing unit system 100 and may be a device that is associated with a particular user. As described below in association with FIGS. 11A-11B, the user device 167 may comprise, for example, a mobile phone, or a tablet, or a laptop, or a personal computer, etc. An example of such a user device 167 include various embodiments described in related U.S. Pat. No. 11,455,092 , titled “METHOD AND SYSTEM FOR MONITORING AND CONTROLLING OPERATIONAL SETTINGS IN A BATHING SYSTEM”, filed on Oct. 19, 2022, the contents of which are incorporated by reference herein.

The controller 160 may supply power from the at least one power source 168 to the different bathing unit components 104 requiring power. The power source 168 may be operative to supply the controller 160 with any conventional power service suitable for residential or commercial use. For example, the at least one power source 168 may supply 240 volts (V) AC to the controller 160 via a service wiring 169. In other embodiments, the power source 168 may instead supply 120 V AC power; in yet other embodiments, the power source 168 may supply both 120 V and 240 V AC power. One skilled in the art will appreciate that alterative embodiments may include other voltage supply values or combinations, and may vary based on geographical location for example. Additionally, other embodiments of the bathing unit system 100 may include other types of power sources 168, such as a stored electrical power source (e.g., battery) and/or locally generated electrical power source (e.g., solar panel or wind/water turbine). Further still, other embodiments of the bathing unit system 100 may include more than one power source 168, an individual power source 168 for each bathing unit component 104, or a power source 168 which is shared by more than one (but not all) bathing unit components 104 of a particular bathing unit system 100. Further still, in some embodiments of the bathing unit system 100, the service wiring 169 is passed through a ground fault circuit interrupter (GFCI) that is adapted for tripping in the presence of a current leakage to ground. The GFCI may provide an additional safety measure to the bathing unit system 100. After receipt of the power from the power source 168, the controller 160 may distribute the power to the different bathing unit components 104 to activate, deactivate and control the different bathing unit components 104 at different operational settings.

### At Least One Pump 140

The at least one pump 140 may generally function to circulate the water 108 from the receptacle 106 through the outlets 114, through the circulation system 110 and back into the receptacle 106 through the inlets 112. In the embodiment shown, the at least one pump 140 includes a first pump 170, a second pump 172 and a third pump 174. Other embodiments of the bathing unit system 100 may include additional or fewer pumps 140.

In the embodiment shown in FIG. 1, one or more of the first, second, and third pumps 170, 172 and 174 may be a powered pump including a motor (not shown) which draws energy from the power source 168 to operate at different operational settings responsive to command signals received from the controller 160 and/or the control panel 162. For example, one or more of the first, second, and third pumps 170, 172 and 174 may be a multi-speed pump having one or more of (a) a “low” mode where the respective motor draws a low amount of energy from the power source 168 and operates at a low-speed (e.g., less than 150 L per minute (LPM)), (b) a “standard” mode where the respective motor draws a standard amount of energy from the power source 168 and operates at a standard-speed (e.g., between 150 LPM and 900 LPM), (c) a “high” mode where the respective motor draws a high amount of energy from the power source 168 and operates at a high speed (e.g., greater than 900 LPM) and (d) an “off” mode where the respective motor draws no energy from the power source 168 and the corresponding pump is off. The “low”, “standard” and “high” modes of a pump may be considered generally “on” modes of that pump. Alternatively, one or more of the first, second and third pumps 170, 172 and 174 may be a variable speed pump and may operate anywhere between 0% and 100% of a maximum speed. In other embodiments, one or more of the first, second, and third pumps 170, 172 and 174 may comprise a dual-speed pump (e.g., with a “low” mode and a “high” mode only) or a single-speed pump (e.g., with a “on” mode only). Additionally, one or more of the first, second, and third pumps 170, 172 and 174 may be controlled through different sequences of the different “on” modes over different periods of time (e.g., a massage sequence). Other embodiments of the bathing unit system 100 may include other types of pumps 140, such as centrifugal pumps, diaphragm pumps, peristaltic pumps, etc.

Each of the first, second and third pumps 170, 172 and 174 may be mapped to one or more seating areas of the two or more seating areas 131 in the receptacle 106, and operational settings for the corresponding pump(s) may be controlled to be directed to one seating area of the two or more seating areas 131. The mapping between a particular pump and a particular seating area may be determined by a manufacturer of the bathing unit system 100 or may be modified/customized by a user of the bathing unit system 100 after installation at a field location of the user. As used herein, the phrase “directed to a seating area” may mean one or more of: (a) affecting a user occupying that seating area more directly or significantly than a user occupying another seating area of the two or more seating areas 131 and (b) affecting only a user occupying that seating area and not a user occupying the other seating area. In the embodiment shown in FIG. 1, the first pump 170 is mapped to the second and third seating areas 132 and 134. The second pump 172 is mapped to the first, second and third seating areas 130, 132 and 134. The third pump 174 is mapped to only the fourth seating area 136, and may, in some embodiments, be mapped to different portions of the fourth seating area 136. Other embodiments of the bathing unit system 100 may include fewer, or alternative or additional mappings between pumps of the at least one pump 140 and seating areas of the two or more seating areas 131. Additionally, mappings between pumps and seating areas may also be modified/customized by a user of the bathing unit system 100.

As described below, different combinations of the first, second and third pumps 170, 172 and 174 and different combination of operational settings thereof may be controlled by the control system 102 based on a user selection of a particular seating area of the two or more seating areas 131. This can allow a user to specifically control operational settings of pumps which are mapped to the selected seating area of the two or more seating areas 131 and/or control a specific user experience in connection with the selected seating area.

### At Least One Diverter Component 142

The at least one diverter component 142 may generally function to switch or divert the flow of the water 108 from one or more pumps 140 away from, or towards, a specific inlet 112 of the plurality of inlets 112 (which, in certain embodiments, directs the flow of the water 108 to one specific seating area or one specific portion of a seating area of the two or more seating areas 131). In the embodiment shown in FIG. 1, the at least one diverter component 142 includes a first diverter valve 180, a second diverter valve 182 and a third diverter valve 184. Other embodiments of the bathing unit system 100 may include additional or fewer diverter components 142; in yet other embodiments, the diverter component 142 may include components other than diverter valves, such as a standalone valve (e.g., butterfly valve, ball control valve, a check valve, etc.) associated with different conduits of the plurality of conduits 116.

In the embodiment shown FIG. 1, one or more of the first, second and third diverter valves 180, 182 and 184 may be a powered valve which draws energy from the power source 168 to operate at different operational settings in responsive to command signals received from the controller 160 and/or the control panel 162. For example, one or more of the first, second and third diverter valves 180, 182 and 184 may be a multi-position diverter valve having, for example, one or more of (a) a “first” position whereby the respective diverter valve diverts 100% of the flow of the water 108 towards a first particular inlet of the plurality of inlets 112 and, in some embodiments, a particular seating area of the two or more seating areas 131 (e.g., the first seating area 130 with the second diverter valve 182), (b) a “second” position whereby the respective diverter valve diverts 100% of the flow of the water 108 towards a second particular inlet and, in some embodiments, a second particular seating area of the two or more seating areas 131 (e.g., the second seating area 132 with the second diverter valve 182), and (c) a “third” position whereby the respective diverter valve diverts 100% of the flow of the water 108 towards a third particular inlet and, in some embodiments, a third particular seating area of the two or more seating areas 131 (e.g., the third seating area 134 with the second diverter valve 182). In other embodiments, the different positions of the one diverter valves may instead divert the flow of the water 108 towards a particular inlet corresponding to a particular portion of one seating area. For example, for the fourth seating area 136, the inlet associated with the “first” position of the third diverter valve 184 may supply jets associated with one seating area portion, whereas the inlet associated with the “second” position of the third diverter valve 184 may supply jets associated with a different seating area portion. In other embodiments, two or more diverter valves may divert the flow of the water 108 towards different inlets of one seating area. For example, for the second seating area 132, the inlet associated with the second diverter valve 182 may supply upper (e.g., chest/arms) jets at the second seating area 132, whereas the inlet associated with the first diverter valve 180 may instead supply lower (e.g., leg) jets at the second seating area 132. Additionally, one or more of the first, second and third diverter valves 180, 182 and 184 may be controlled through different sequences of the different positions over different periods of time (e.g., in a massage sequence).

In some embodiments, one or more of the first, second and third diverter valves 180, 182 and 184 may be a dual-position diverter valve having, for example, only a “first” position and a “second” position. Such examples may be used when the diverter valves are only associated with two different seating areas of the two or more seating areas 131. For example, the first diverter valve 180 is only mapped to the second and third seating areas 132 and 134.

In some embodiments, one or more of the first, second and third diverter valves 180, 182 and 184 may be a variable position valve and may operate each position between 0% and 100% of a maximal opening, and/or may operate different positions proportionally between 0% and 100%. For example, in some embodiments, while in the “first” position, a particular diverter valve might divert anywhere between 0% and 100% of the flow of the water 108 towards the first particular inlet responsive to command signals received from the controller 160 and/or the control panel 162, and the remaining flow of the water 108 towards the remaining inlets mapped to the diverter valve (e.g., equally as described below; however one skilled in the art will appreciate that alternative embodiments may include unequal distribution to remaining inlets). As another example, in embodiments where a particular diverter valve is associated with a plurality of different inlets, the diverter valve may divert different percentages of the flow of the water 108 proportionally to different inlets responsive to command signals received from the controller 160. Specifically, in embodiments where the diverter valve includes two different positions, the diverter valve may include (a) an “equal” position whereby the diverter valve diverts 50% of the flow of the water 108 to the first particular inlet and 50% to the second particular inlet, (b) a “first favouring” position whereby the diverter valve is operable to divert anywhere between 51% to 100% of the flow to the first particular inlet, and the proportionally remaining percentage of the flow to the second particular inlet and (c) a “second favouring” position whereby the diverter valve is operable to divert anywhere between 51% to 100% of the flow to the second particular inlet, and the proportionally remaining percentage of the flow to the first particular inlet. A similar system may be implemented for embodiments where the diverter valve includes more than two different positions (e.g., three, four, five different positions, etc.), whereby a “favouring” position allows the diverter valve to divert a certain percentage of the flow to a particular favoured inlet, and the proportionally remaining percentage of the flow may be split (e.g., equally or unequally) amongst the remaining inlets.

In other embodiments, one or more of the first, second and third diverter valves 180, 182 and 184 may be a manual valve requiring manual actuation by a user in order to operate at different operational settings and in different positions. In such embodiments, users may be prompted (e.g., by the control panel 162 and/or the user device 167) to manually actuate the diverter valve to a particular operational setting (e.g., a particular position) in response to command signals received from the controller 160 and/or the control panel 162.

As alluded to above, each of the first, second and third diverter valves 180, 182 and 184 may be mapped to one or more seating areas of the two or more seating areas 131, and operational settings for the corresponding diverter valve(s) may be controlled to be directed to one seating area versus another seating area. The mapping between a particular diverter valve and a particular seating area may be determined by a manufacturer of the bathing unit system 100 or may be modified/customized by a user of the bathing unit system 100 after installation at the field location. In the embodiment shown in FIG. 1, the first diverter valve 180 is mapped to the second and third seating areas 132 and 134, and may particularly be mapped to the lower jets of the second seating area 132 as described above. The second diverter valve 182 is mapped to the first, second and third seating areas 130, 132 and 134, and may particularly be mapped to the upper jets of the second seating area 132 as described above. The third diverter valve 184 is mapped to only the fourth seating area 136, and may particularly be mapped to a first portion, a second portion and a third portion of the fourth seating area 136. Other embodiments of the bathing unit system 100 may include fewer, or alternative or additional mappings between diverter components of the at least one diverter component 142 and seating areas of the two or more seating areas 131. Additionally, mappings between diverter valves and seating areas may also be modified/customized by a user of the bathing unit system 100.

As described below, different combinations of the first, second and third diverter valves 180, 182 and 184 and different combination of operational settings thereof may be controlled by the control system 102 based on a user selection of a particular seating area of the two or more seating areas 131. This can allow a user to specifically control operational settings of the diverter valves which are mapped to the selected seating area and/or control a specific user experience in connection with the selected seating area.

### At Least One Air Blower 143

The at least one air blower 143 may generally function to introduce air to the water 108 in the receptacle 106, and may add the air directly to the receptacle 106 via one or more inlets of the inlets 112 or may add the air to the water 108 in the conduits 116 instead. In the embodiment shown, the at least one air blower 143 includes a first air blower 190 and a second air blower 192; one skilled in the art will appreciate that alterative embodiments may include additional or fewer air blowers 143.

In the embodiment shown, one or more of the first and second air blowers 190 and 192, may be a powered air blower including a motor (not shown) which draws energy from the power source 168 to operate at different operational settings in response to command signals received from the controller 160 and/or the control panel 162. For example, one or more of the first and second air blowers 190 and 192 may be a multi-setting blower having, for example, one or more of (a) a “low” mode where the respective motor draws a low amount of energy from the power source 168 and operates at a low-speed (e.g., less 10,000 rotations per minute (RPM)), (b) a “standard” mode where the respective motor draws a standard amount of energy from the power source 168 and operates at a standard-speed (e.g., between 10,000 RPM and 20,000 RPM), (c) a “high” mode where the respective motor draws a high amount of energy from the power source 168 and operates at a high speed (e.g., greater than 20,000 RPM) and (d) an “off” mode where the respective motor draws no energy from the power source 168 and the air blower is off. The “low”, “standard” and “high” modes of an air blower may be considered generally “on” modes of that air blower. In other embodiments, one or more of the first and second air blowers 190 and 192 may be a variable speed blower and may operate anywhere between 0% and 100% of a maximum speed; may comprise a dual-speed blower (e.g., with the “low”, “standard” and “off” mode described above only); or may comprise a single-speed blower (e.g., with the “standard” and “off” mode described above only).

Additionally, each of the first and second air blowers 190 and 192 may be mapped to one or more seating areas of the two or more seating areas 131 in the receptacle 106, and operational settings for the corresponding air blower(s) may be controlled to be directed to one seating area of the two or more seating areas 131. The mapping between a particular diverter valve and a particular seating area may be determined by a manufacturer of the bathing unit system 100 or may be modified/customized by a user of the bathing unit system 100. In the embodiment shown in FIG. 1, the first air blower 190 is mapped to the first, second and third seating areas 132, 134 and 136, whereas the second air blower 192 is mapped to the fourth seating area 136. Further, in the embodiment shown in FIG. 1, the first air blower 190 is configured to introduce air into the conduits 116 associated with the first, second and third seating areas 130, 132 and 134, as well as directly into the receptacle 106 proximate the first, second and third seating areas 130, 132 and 134. Similarly, the second air blower 192 is configured to introduce air into the conduits 116 associated with the fourth seating area 136, as well as directly into the receptacle 106 proximate the fourth seating area 136. Other embodiments of the bathing unit system 100 may include fewer, or alternative or additional mappings between air blowers of the at least one air blower 143 and seating areas of the two or more seating areas 131. Additionally, mappings between air blowers and seating areas may also be modified/customized by a user of the bathing unit system 100.

As described below, different combinations of the first and second air blowers 190 and 192 and different combination of operational settings thereof may be controlled by the control system 102 based on a user selection of a particular seating area of the two or more seating areas 131. This can allow a user to specifically control operational settings of the air blowers which are mapped to the selected seating area and/or control a specific user experience in connection with the selected seating area.

### At Least One Light 150, at Least One Speaker 152 and at Least One Visual Display 154

The at least one light 150 may located in or around the receptacle 106, and may generally function to light the water 108 within the receptacle 106 or the area around the bathing unit system 100 for ambience. The at least one speaker 152 may be located in or around the receptacle 106 may generally function to provide audio to users within the receptacle 106 or the area around the bathing unit system 100 for ambience. The at least one visual display 154 may generally be located in the area around the bathing unit system 100, and may generally function to display video and provide audio to users within the receptacle 106 or the area around the bathing unit system 100 for ambience. In the embodiment shown in FIG. 2, the bathing unit system 100 includes (a) a first set of lights 200, a second set of lights 202, a third set of lights 204, and a fourth set of lights 206; (b) a first set of speakers 210 and a second set of speakers 212; and (c) a first display screen 220 and a second display screen 222. Other embodiments of the bathing unit system 100 may include additional or fewer lights 150, speakers 152 and visual displays 154, or may omit one or more of the lights 150, speakers 152 and the visual displays 154 altogether. In yet other embodiments, the lights 150, speakers 152 and visual displays 154 may have different form factors or may be positioned at different locations in the receptacle 106 and/or the area around the bathing unit system 100.

In the embodiment shown, the first, second, third and fourth set of lights 200, 202, 204 and 206 may be powered by the power source 168 and may be controlled to operate in different operational settings in response to command signals received from the controller 160 and/or the control panel 162. For example, one or more of the first, second, third and fourth set of lights 200, 202, 204 and 206 may be turned on and off, may have different colour settings, may have different brightness settings, and/or may be controlled through different sequences of colour and brightness settings over different periods of time (e.g., an ambience sequence). Similarly, the first and second set of speakers 210 and 212 may be powered by the power source 168 and may be controlled to operate in different operational settings in response to in response to command signals received from the controller 160 and/or the control panel 162. For example, the first and second set of speakers 210 and 212 may be turned on and off, may have different volume settings, may be controlled to stream or project different types of audio data, and/or stream or project different types of audio data over a period of time (e.g., an ambience setting). Similarly still, the first and second display screens 220 and 222 may be powered by the power source 168 and may be controlled to operate in different operational settings in response to in response to command signals received from the controller 160 and/or the control panel 162. For example, the first and second display screens 220 and 222 may be turned on and off, may have different volume settings, may have different brightness settings, may be controlled to stream or present different types of multimedia data, and/or stream or present different types of multimedia data over a period of time (e.g., an ambience setting).

Each of the first, second, third and fourth set of lights 200, 202, 204 and 206, the first and second set of speakers 210 and 212, the first and second display screens 220 and 222 may be mapped to one or more seating areas of the two or more seating areas 131 in the receptacle 106, and operational settings for the corresponding air light(s), speaker(s) and display screen(s) may be controlled to be directed to one seating area of the two or more seating areas 131. In the embodiment shown in FIG. 2, the first set of lights 200 is mapped to the first seating area 130, the second set of lights 202 is mapped to the second seating area 132, the third set of lights 204 is mapped to the third seating area 134, and the fourth set of lights 206 is the mapped to the fourth seating area 136. In some embodiments, a set of lights may also be mapped to an opposing seating area, to ensure that lights directly facing a user occupying the opposing seating area is not too bright. For example, the first, second and third sets of lights 200, 202 and 204 may also be mapped to the fourth seating area 136, whereas the fourth set of lights 206 may also be mapped to the first, second and third seating areas 130, 132, and 134. Similarly, in the embodiment shown in FIG. 2, the first set of speakers 210 is mapped to the first, second and third seating areas 130, 132, and 134, whereas the second set of speakers 212 is mapped to the fourth seating area 136. Similarly still, in the embodiment shown in FIG. 2, the first display screen 220 is mapped to the first, second and third seating areas 130, 132, and 134 and the second display screen 222 is mapped to the fourth seating area 136. Additionally, mappings between lights, speakers, display screens and seating areas may also be modified/customized by a user of the bathing unit system 100.

As described below, different combinations of the first, second, third and fourth set of lights 200, 202, 204 and 206, the first and second set of speakers 210 and 212, the first and second display screens 220 and 222 and different combination of operational settings thereof may be controlled by the control system 102 based on a user selection of a particular seating area of the two or more seating areas 131. This can allow a user to specifically control operational settings of lights, speakers and display screen(s) which are mapped to the selected seating area and/or control a specific user experience in connection with the selected seating area.

### At Least One Temperature Change Component 146 and at Least One Sensor 148

The at least one temperature change component 146 may generally function to change a temperature of the water 108 flowing through the circulation system 110 and within the receptacle 106 by inputting thermal energy or by removing thermal energy. In the embodiment shown, the at least one temperature change component 146 may include a primary heater 230 generally configured to heat the water 108, a primary cooler 232 generally configured to cool the water 108 and a combined auxiliary heater/cooler 234 generally configured to assist the primary heater and cooler 230 and 232 to heat and cool the water 108 as applicable. In other embodiments, the bathing unit system 100 may include additional, fewer or alternative temperature change components 146.

The primary heater 230 may be an electrical heater including a heating element which draws energy from the power source 168. The primary cooler 232 may be a thermoelectric cooling element which draws energy from the power source 168 to transfer heat from one surface of the primary cooler 232 (e.g., a cold surface) to another surface of the primary cooler 232 (e.g., a hot surface). The auxiliary heater/cooler 234 may be a heat transfer module such as a heat pump which draws energy from the power source 168 to transfer thermal energy from one area (e.g., cool area) to another area (e.g., hot area). In the embodiment shown, the primary heater and cooler 230 and 232 and the auxiliary heater/cooler 234 may be operable in, for example, (a) a “low” mode where the corresponding element draws a low amount of energy from the power source 168, (b) a “standard” mode where the corresponding element draws a standard amount of energy from the power source 168, (c) a “high” mode where the corresponding element draws high amount of energy from the power source 168 and (d) an “off” mode where the corresponding element draws no energy from the power source 168. The “low”, “standard” and “high” modes of a temperature change component may be considered “on” modes of that temperature change component. In other embodiments, the primary heater and cooler 230 and 232 and the auxiliary heater/cooler 234 may be a percentage modulated, and the corresponding element may operate anywhere between 0% and 100% of a maximum temperature change capacity, and may draw anywhere between 0% and 100% of a maximum amount of energy from the power source 168. One skilled in the art will appreciate that alterative embodiments of the primary heater and cooler 230 and 232 and the auxiliary heater/cooler 234 are available.

The at least one sensor 148 may comprise a variety of different sensors. For example, in some embodiments, the at least one sensor 148 may include sensors which sense attributes of the water 108 with in the receptacle 106, including temperature sensors, depth sensors, flow sensors, pH sensors, ORP sensors, turbidity sensors etc. In other embodiments, the at least one sensor 148 may include environmental sensors which sense environmental factors of an environment around the bathing unit system 100, including ambient temperature sensors, humidity sensors, light sensors, windspeed sensors, precipitation sensors, etc. In yet other embodiments, the least one sensor 148 may include occupancy sensors which sense occupancy of different seating areas of the two or more seating areas 131, including motion sensors, weight sensors, proximity sensors etc. In yet other embodiments, the least one sensor 148 may include interaction sensors which sense user interaction, and in particular user interactions selecting a particular seating area of the two or more seating areas 131, including motion sensors, a microphone, a camera, etc.

In the embodiment shown in FIG. 2, the at least one sensor 148 includes a first sensor 240 mapped to the first seating area 130, a second sensor 242 mapped to the second seating area 132, a third sensor 244 mapped to the third seating area 134, and a fourth sensor 246 mapped to the fourth seating area 136. In the embodiment shown in FIG. 2, the first, second, third and fourth sensors 240, 242, 244 and 246 may comprise the occupancy sensors which sense whether the correspondingly mapped seating areas 130, 132, 134 and 136 are occupied by a user. For example, the first, second, third and fourth sensors 240, 242, 244 and 246 may comprise a weight sensor on or proximate the corresponding first, second, third and fourth seating areas 130, 132, 134 and 136 which transmit a signal when a weight is placed on the corresponding seating area; additionally or alternatively, the occupancy sensors 240, 242, 244 and 246 may instead comprise motion sensors on or proximate the corresponding seating area which transmits a signal when motion is detected around the corresponding seating area; additionally or alternatively, the occupancy sensors 240, 242, 244 and 246 may instead comprise proximity sensors on or proximate the seating area which transmits a signal when a corresponding receiver (e.g., in the user device 167, or other wearable device, associated with the user) is placed within a certain range (e.g., 10 cm to 1 m) of the proximity sensor.

In yet other embodiments, the first, second, third and fourth sensors 240, 242, 244 and 246 may also comprise sensors which sense attributes of the water 108 around the correspondingly mapped seating areas 130, 132, 134 and 136, and/or environmental factors around the correspondingly mapped seating areas 130, 132, 134 and 136.

In yet other embodiments, the at least one sensor 148 may comprise the interaction sensors which detect a user interaction selecting a seating area of the two or more seating areas 131. For example, the at least one sensor 148 may comprise at least one microphone configured to detect a user interaction comprising a voice command conveying the user selection of the seating area, or may comprise at least one camera configured to detect a user interaction comprising a movement command conveying user selection of the seating area. One skilled in the art will appreciate that alterative embodiments may include additional or alternative interaction sensors and/or technology, such as an algorithm which tracks eye movement, etc.

In some embodiments, different combinations of the primary heater and cooler 230 and 232 and the auxiliary heater/cooler 234 and different combination of operational settings thereof may be controlled by the control system 102 based on a user selection of a particular seating area of the two or more seating areas 131. This can allow a user to control a temperature of the water 108 after the user has selected the particular seating area; however, as the primary heater and cooler 230 and 232 and the auxiliary heater/cooler 234 typically change the temperature of all the water 108 in the circulation system 110, the control of the temperature of the water 108 may not be on a seating area specific basis. Additionally, information received from different combinations of the first, second, third and fourth sensors 240, 242, 244 and 246 may be received by the controller 160 and/or the control panel 162 and may be used to generate the command signals in order to control operational settings of the set of bathing unit components 104.

### Controller 160

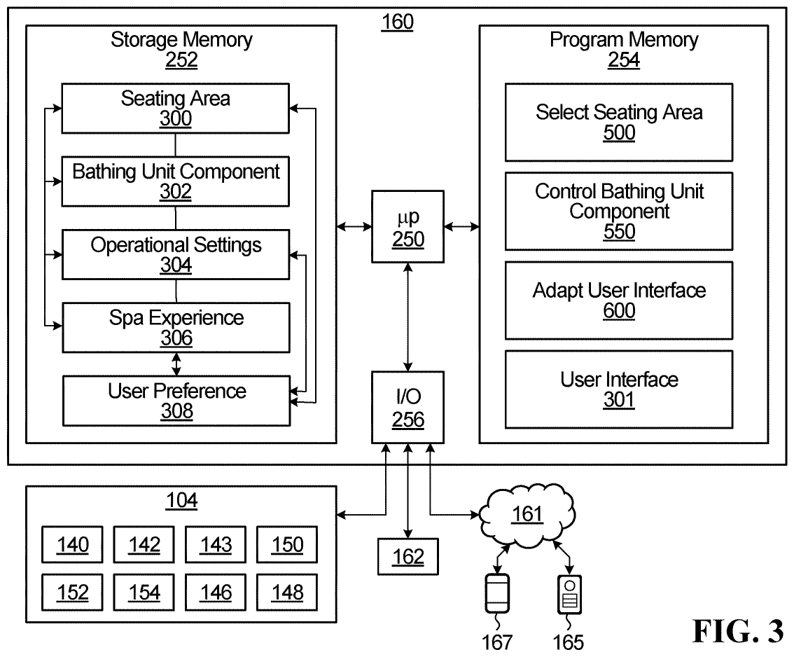

As described above, the controller 160 may be implemented as the local controller, alone or in combination with the remote server 165. In the embodiment shown in FIG. 3, the controller 160 includes at least one local processor 250, a storage memory 252, a program memory 254 and a I/O interface 256, all in communication with the local processor 250. Other embodiments of the controller 160 may include fewer, additional or alternative components. Additionally, although only a single local processor 250, single storage memory 252, single program memory 254 and single I/O interface 256 is shown in FIG. 3, other embodiments of the controller 160 may include more than one of each of these components. For example, the controller 160 may include at least one first processor positioned topside the receptacle 106 of the bathing unit system 100 configured to perform some of the functions of the controller 160 and at least one second processor positioned within a cabinet of the bathing unit system 100 configured to perform other functions of the controller 160.

The I/O interface 256 includes an interface for the local processor 250 to communicate commands to, and receive information from, the bathing unit components 104, including the at least one pump 140, the at least one diverter component 142, the at least one temperature change component 146, the at least one sensor 148, the at least one air blower 143, the at least one light 150, the at least one speaker 152, and the at least one visual display 154 for example. In the embodiment shown in FIGS. 1-3, the local processor 250 communicates with these bathing unit components 104 via a wired connection 163; in other embodiments, the local processor 250 may also communicate with the bathing unit components 104 over a wireless network 161. The I/O interface 256 may further include a communication module which enables the local processor 250 to communicate with one or more of (a) a remote processor 260 of the remote server 165 (e.g. over the wireless network 161), (b) a user device processor 280 of the user device 167 (e.g., over the wireless network 161), and (c) a panel processor 270 of the topside control panel 162 (e.g., over the wired connection 163 and/or over the wireless network 161). The I/O interface 256 may include any communication interface which enables the local processor 250 to communicate with the bathing unit components 104, the control panel 162, and optionally the user device 167 and the remote server 165 as described above, including specialized or standard I/O interface technologies such as channel, port-mapped, asynchronous for example.

The storage memory 252 stores information received or generated by the local processor 250 and may generally function as an information or data store. In the embodiment shown, the storage memory 252 may include a seating area data store 300, a bathing unit component data store 302, an operational settings data store 304, a spa experience data store 306 and a user preference data store 308.

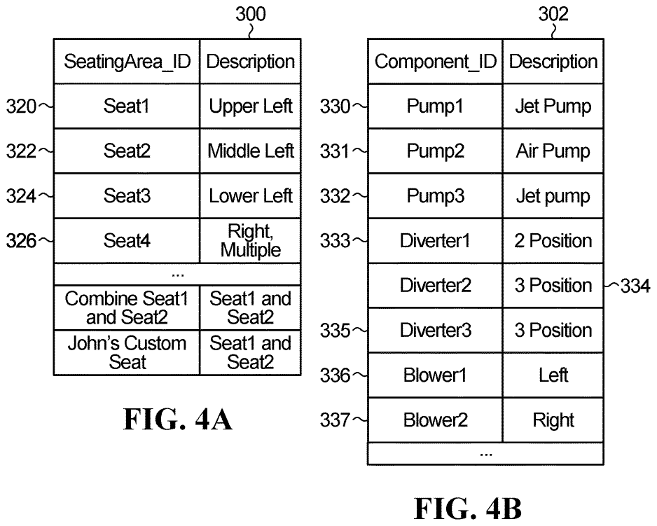

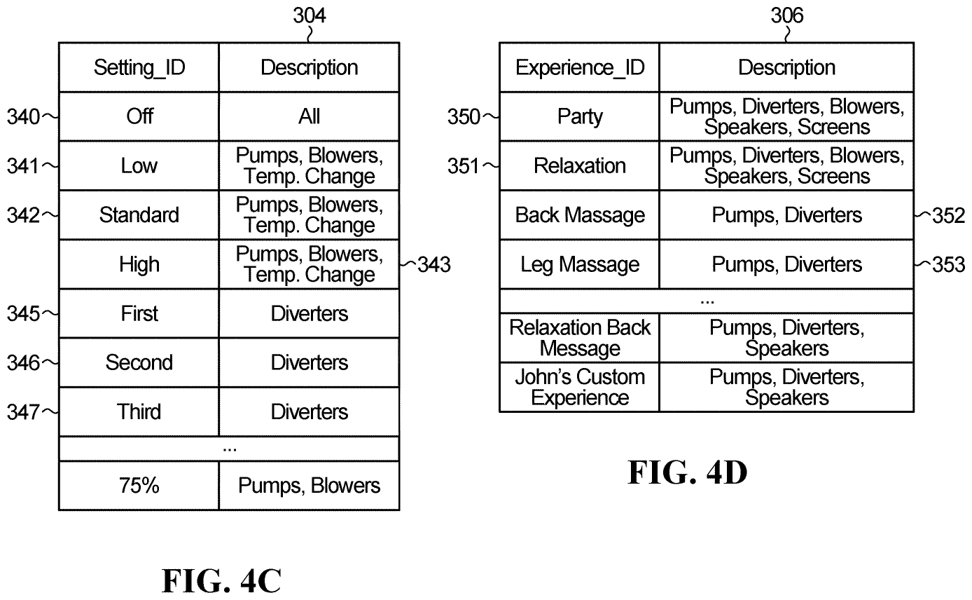

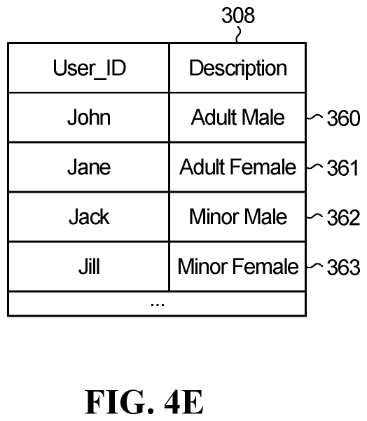

The seating area data store 300 may store entries directed to different seating areas of the two or more seating areas 131 (shown in FIGS. 1 and 2). Each entry in the seating area data store 300 may be associated with a corresponding unique seating area identifier (e.g., seatingarea_ID) and a description. For example, in the embodiment shown in FIG. 4A, the seating area data store 300 includes: entry 320 corresponding to the first seating area 130 having a seatingarea_ID of “seat1”, entry 322 corresponding to the second seating area 132 having a seatingarea_ID of “seat2”, entry 324 corresponding to the third seating area 134 having a seatingarea_ID of “seat3”, and entry 326 corresponding to the fourth seating area 136 having a seatingarea_ID of “seat4”. One skilled in the art will appreciate that alterative embodiments of the seating area data store 300 may include more, fewer or alternative entries based on a number of seating areas of the two or more seating areas 131 of a particular receptacle 106 and may also have a different data store structure. Additionally, a user of the bathing unit system 100 may modify/customize the different seating areas based on their personal preference; for example, a user may prefer a combination of a standard first and second seating areas 130 and 132 as a combined seating area, which may allow the user to sit in the first seating area 130 and stretch their legs into the second seating area 132 to receive a specific to massage sequence at the on their legs, and may generate a new entry for this combination for the seating area data store 300 and having a seatingarea_ID of “Combined Seat1 and Seat2” or “John's Custom Seat”.

The bathing unit component data store 302 may store entries directed to different bathing unit components 104 of the plurality of bathing unit components 104 (shown in FIGS. 1 and 2). Each entry in the seating area data store 300 may be associated with a corresponding unique bathing unit component identifier (e.g., component_ID) and a description. For example, in the embodiment shown in FIG. 4B, the bathing unit component data store 302 includes: entry 330 directed to the first pump 170 having a component_ID of “pump1”; entry 331 directed to the second pump 172 having a component_ID of “pump2”; entry 332 directed to the third pump 174 having a component_ID of “pump3”; entry 333 directed to the first diverter valve 180 having a component_ID of “diverter1”; entry 334 directed to the second diverter valve 182 having a component_ID of “diverter2”; entry 335 directed to the third diverter valve 184 having a component_ID of “diverter3”; entry 336 directed to the first air blower 190 having a component_ID of “airblower1”; entry 337 directed to the second air blower 192 having a component_ID of “airblower2”, etc. Although not shown in FIG. 4B, the bathing unit component data store 302 stores additional entries directed to the other bathing unit components described above, including without limitation, entries directed to the first set of lights 200 (e.g., each light individually and/or the set of lights as a group), the second set of lights 202, the third set of lights 204, the fourth set of lights 206, the first set of speakers 210 (e.g., each a speaker individually and/or the set of speakers as a group), the second set of speakers 212, the first display screen 220, the second display screen 222, the primary heater 230, the primary cooler 232, the auxiliary heater/cooler 234, the first sensor 240, the second sensor 242, the third sensor 244 and the fourth sensor 246. One skilled in the art will appreciate that alterative embodiments of the bathing unit component data store 302 may include more, fewer or alternative entries based on a number of bathing unit components 104 which form a particular bathing unit system 100 and may also have a different data store structure.

The operational settings data store 304 may store entries directed to different operational settings of different bathing unit components 104 described above. Each entry in the operational settings data store 304 may be associated with a unique operational setting identifier (e.g., setting_ID) and a description. For example, in the embodiment shown in FIG. 4C, the operational settings data store 304 includes: entry 340 generally corresponding to the “off” mode for the various bathing unit components 104 and having a setting_ID of “off”; entry 341 generally corresponding to the “low” mode for the various bathing unit components 104 and having a setting_ID of “low”; entry 342 generally corresponding to the “standard” mode for the various bathing unit components 104 and having a setting_ID of “standard”; entry 343 generally corresponding to the “high” mode for the various bathing unit components 104 and having a setting_ID of “high”; entry 345 generally corresponding to the “first” position for the some bathing unit components 104 and having a setting_ID of “first”; entry 346 generally corresponding to the “second” position for the some bathing unit components 104 and having a setting_ID of “second”; entry 347 generally corresponding to the “third” position for the some bathing unit components 104 and having a setting_ID of “third”; etc. The operational settings data store 304 stores additional entries directed to the various other modes of operating the various bathing unit components 104, including without limitation, entries directed to operating a particular bathing unit component at a certain percentage of a max, entries directed to operating a particular bathing unit component to stream, project or present specific audio, visual and/or multi-media content, etc. One skilled in the art will appreciate that alterative embodiments of the operational settings data store 304 may include more, fewer or alternative entries based on a number of bathing unit components 104 which form a particular bathing unit system 100, the complexity of operation of such bathing unit components 104 and may have a different data store structure. Additionally, a particular operational setting of one or more bathing unit components 104 may be be modified/customized by a user of the bathing unit system 100 after installation; for example, a user may prefer to use the first pump 170 and the second pump 172 at a 75% of a maximum speed and may generate a new entry for the operational settings data store 304 corresponding to this operational setting and having a setting_ID of “75%”.

The spa experience data store 306 may store entries directed to different spa experiences and ambiences. The phrase “spa experience” as used herein may correspond to a user selectable experience which involve concurrent or non-concurrent activation, deactivation and control of more than one bathing unit component 104 associated with a particular bathing unit system 100. For example, a particular “spa experience” may involve operating one or more bathing unit components at different operational settings, and may involve operating such different operational settings for different periods of time and/or according to a particular sequence. Additionally or alternatively, a particular “spa experience” may involve operating one or more bathing unit components to stream, project or present a specific audio, visual and/or multimedia content, and may involve streaming, projecting or presenting such content for a particular period of time and/or according to a particular sequence. Each entry in the spa experience data store 306 may be associated with a unique experience identifier (e.g. experience_ID) and a description. For example, in the embodiment shown in FIG. 4D, the spa experience data store 306 may include: entry 350 corresponding to a “party” experience having an experience_ID of “party”; entry 351 corresponding to a “relaxation” experience having an experience_ID of “relaxation”; entry 352 corresponding to a “back massage” experience having an experience_ID of “back massage”; entry 353 corresponding to a “leg massage” experience having an experience_ID of “leg massage”. In other embodiments, the spa experience data store 306 may include an entry corresponding to a “deep massage” experience having an experience_ID of “deep massage”; an entry corresponding to a “light massage” experience having an experience_ID of “light massage”; etc. One skilled in the art will appreciate that alterative embodiments of the spa experience data store 306 may include more, fewer or alternative entries based on a number of spa experiences programmed by a manufacturer or a user, a number of bathing unit components 104 which form a particular bathing unit system 100, the complexity of operation of such bathing unit components 104, and may have a different data store structure. Additionally, a user of the bathing unit system 100 may modify and customize a spa experience based on their personal preference; for example, a user may prefer a combination of the “relaxation” experience due to the multimedia content streamed, but prefer a “back massage” experience for the intensity of the generated jets, and may generate a new entry for this experience for the spa experience data store 306 and having a experience_ID of “relaxation back massage” or “John's custom experience”.

The user preference data store 308 may store entries directed to different users of a particular bathing unit system 100. Each entry in the user preference data store 308 may be associated with a unique experience identifier (e.g. user_ID) and a description. For example, in the embodiment shown in FIG. 4E, the user preference data store 308 may include: entry 360 corresponding to a first user named John and having an user_ID of “John”; entry 361 corresponding to a second user named Jane and having an user_ID of “Jane”; entry 362 corresponding to a third user named Jack and having an user_ID of “Jack”; entry 363 corresponding to a fourth user named Jill and having an user_ID of “Jill”. One skilled in the art will appreciate that alterative embodiments of the the user preference data store 308 may include more, fewer or alternative entries based on a number of users using a particular bathing unit system 100 and my have a different data store structure. Additionally, a user of the bathing unit system 100 may add themselves and may generate a new entry for user preference data store 308 having the user_ID of “new user”or “James”.

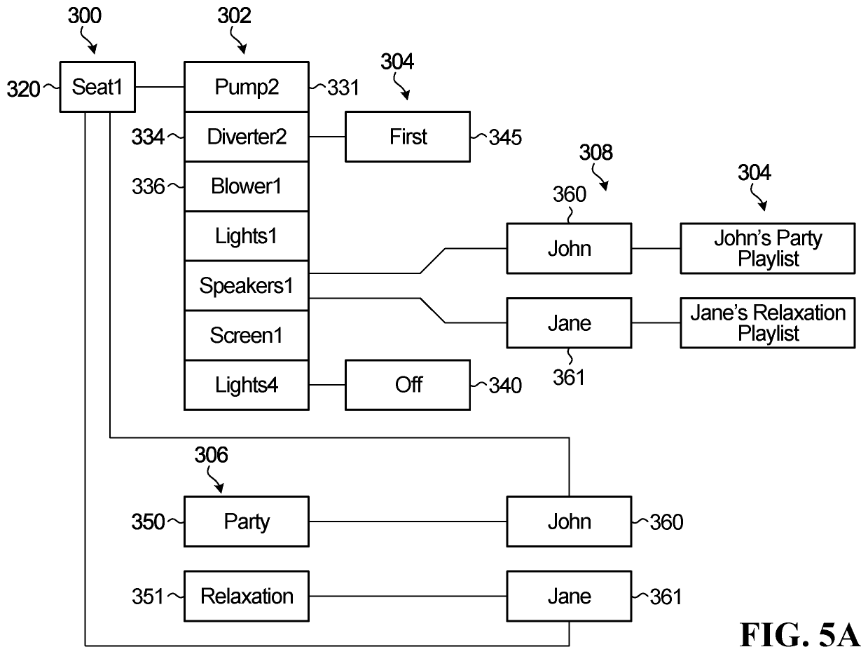

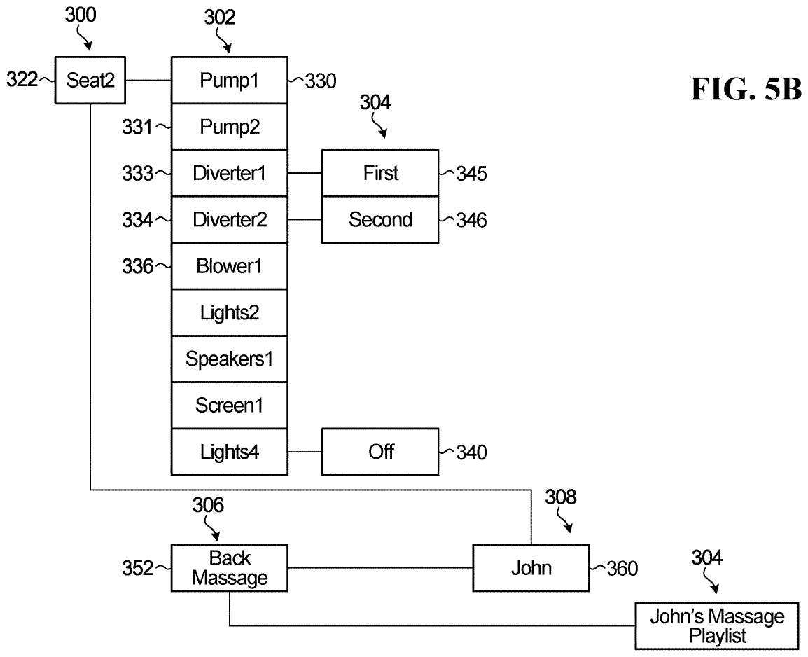

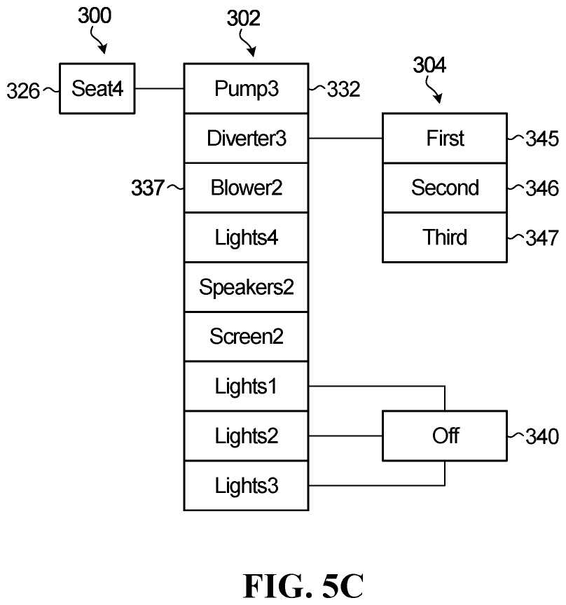

A particular entry in the seating area data store 300 (having a particular seatingarea_ID) may identify one or more bathing unit component identifiers (e.g., component_ID) of the bathing unit components data store 302, thereby provide mappings (e.g., associations) between a seating area of the two or more seating areas 131 and one or more bathing unit components of the plurality of bathing unit components 104. The bathing unit components which are mapped to a particular seating area form a “set of bathing unit components” mapped to that particular seating area. As a more specific example, referring to FIG. 5A, the entry 320 corresponding to the first seating area 130 may be mapped to the entry 331 corresponding to the second pump 172, the entry 334 corresponding to the second diverter valve 182, the entry 336 corresponding to the first air blower 190, an entry corresponding to the first set of lights 200, an entry corresponding to the first set of speakers 210 and an entry corresponding to the first display screen 220. In some embodiments, the entry 320 corresponding to the first seating area 130 may also be mapped to an entry corresponding to the fourth set of lights 206 to control the fourth set of lights 206 to (e.g., to dim this set of lights or to turn this set of lights off). The second pump 172, the second diverter valve 182, the first air blower 190, the first set of lights 200, the fourth set of lights 206, the first set of speakers 210 and the first display screen 220 form a “first set of bathing unit components” mapped to the first seating area 130.

In contrast, referring to FIG. 5B, the entry 322 corresponding to the second seating area 132 may be mapped to the entry 330 corresponding to the first pump 170, the entry 331 corresponding to the second pump 172, the entry 333 corresponding to the first diverter valve 180, the entry 334 corresponding to the second diverter valve 182, the entry 336 corresponding to the first air blower 190, an entry corresponding to the second set of lights 202, the entry corresponding to the fourth set of lights 206, the entry corresponding to the first set of speakers 210 and the entry corresponding to the first display screen 220. The first pump 170, the second pump 172, the first diverter valve 180, the second diverter valve 182, the first air blower 190, the second set of lights 202, the fourth set of lights 206, the first set of speakers 210 and the first display screen 220 form a “second set of bathing unit components”mapped to the second seating area 132.

As a further contrast, referring to FIG. 5C, the entry 326 corresponding to the fourth seating area 136 may be mapped to: the entry 332 corresponding to the third pump 174; the entry 335 directed to the third diverter valve 184; the entry 337 corresponding to the second air blower 192; an entry corresponding to the fourth set of lights 206; an entry corresponding to the second set of speakers 212; and an entry corresponding to the second display screen 222. As described above, in some embodiments, the entry 326 corresponding to the fourth seating area 136 may also be mapped to entries corresponding to the first, second and third sets of lights 200, 202 and 204 (e.g., to dim these sets of lights or to turn these sets of lights off). In such embodiments, the third pump 174, the third diverter valve 184, the second air blower 192, the first, second, third and fourth set of lights 200, 202, 204 and 206, the second set of speakers 212, and the second display screen 222 form a “fourth set of bathing unit components”mapped to the fourth seating area 136.

Different seating areas of the two or more seating areas 131 may include at least one common bathing unit component which are mapped to both seating areas. For example, the first seating area 130 and the second seating area 132 include at least one common bathing unit component which are present in both the first set of bathing unit components and the second set of bathing unit components (e.g., one or more of the second pump 170, the second diverter valve 182, the first air blower 190, the fourth of lights 206, the first set of speakers 210 and the first display screen 220). The different seating areas may also include separate bathing unit components. For example, the first seating area 130 and the second seating area 132 include separate bathing unit components which are only present in the second set of bathing unit components (e.g., one or more of the first pump 170, the first diverter valve 180, the first set of lights 200 and the second set of lights 202)

Further, in some embodiments, a particular entry in the seating area data store 300 may further identify one or more operational setting identifiers (e.g., setting_ID) of the operational settings data store 304, thereby providing mappings (associations) between a seating area of the two or more seating areas 131 and one or more operational settings of the set of bathing unit components which are mapped to that seating area. For example, referring to FIG. 5A, the entry 320 corresponding to the first seating area 130 may be mapped to the entry 334 (in the bathing unit component data store 302) corresponding to the second diverter valve 182 and the entry 345 (in the operational settings data store 304) corresponding to the “first” position for the second diverter valve 182. In contrast, referring to FIG. 5B, the entry 322 corresponding to the second seating area 132 may be mapped to the entry 334 (in the bathing unit component data store 302) corresponding to the second diverter valve 182 and the entry 346 (in the operational settings data store 304) corresponding to the “second” position for the second diverter valve 182. This may direct the operation of a common bathing unit component (e.g., the second diverter valve 182) towards one seating area (e.g. the first seating area 130 or the second seating area 136) when that seating area is selected by a user.

Further, in some embodiments, a particular entry in the spa experience data store 306 may identify one or more bathing unit component identifiers (e.g., component_ID) of the bathing unit components data store 302 and one or more operational setting identifiers (e.g., setting_ID) of the operational settings data store 304, thereby provide mappings (associations) between a particular spa experience and one or more operational settings of one or more bathing unit components. This may allow the controller 160 and/or the control panel 162 to control different combinations of the bathing unit components 104 to implement a particular spa experience. For example, the entry 350 corresponding to the “party” experience may be mapped to the entry 336 corresponding to the first air blower 190, the entry 337 corresponding to the second air blower 192, and the entry 343 corresponding to the “high” mode, indicating that the “party” experience involves operating the first and second air blowers 190 and 192 in the “high” mode to introduce a large amount of air into the water 108. Additionally, the entry 350 may also be mapped to the entries corresponding to the first set of speakers 210 and/or the second set of speakers 212 and entries corresponding to streaming of party/lively audio, indicating that the “party” experience should also be associated with operating the first set of speakers and/or the second set of speakers 212 to stream or project party music. In contrast, the entry 351 corresponding to the “relaxation” experience may be mapped to the entry 336 corresponding to the first air blower 190, the entry 337 corresponding to the second air blower 192, and the entry 340 corresponding to the “off” mode, indicating that the “relaxation” experience involve deactivating the first and second air blowers 190 and 192 introduce no air into the water 108 and to promote a more relaxing ambience. Similarly, the entry 351 may also be mapped to the entries corresponding to the first set of speakers 210 and/or the second set of speakers 212 and entries corresponding to streaming of relaxing audio, indicating that the “relaxation” experience should also be associated with operating the first set of speakers 210 and/or the second set of speakers 212 to stream or project relaxing music.

Further, in some embodiments, entries in the seating area data store 300, the operational settings data store 304 and the spa experience data store 306, may identify one or more user identifiers (e.g., user_ID) of the user preference data store 308, thereby provide mappings (associations) between a particular seating area, a particular operational setting, and/or a particular spa experience and one or more users. This may allow the controller 160 and/or the control panel 162 to control the bathing unit components 104 to implement customized seating areas, customized operational settings, and/or customized spa experiences based on the user that is using the bathing unit system 100.

The mappings (associations) between entries in the seating area data store 300 and the entries in the bathing unit component data store 302, alone or in combination with the entries in the operational settings data store 304, the spa experience data store 306 and the user preference data store 308, may allow the controller 160 and/or the control panel 162 to control at least one of: (a) the operational settings of a set of the bathing unit components mapped to a particular seating area and (b) the specific spa experience at the particular seating area by controlling the set of bathing unit components mapped to that particular seating area. The mappings (associations) between entries in the seating area data store 300 and the entries in the bathing unit component data store 302, alone or in combination with the entries in the operational settings data store 304, the spa experience data store 306 and the user preference data store 308 thus form “seating area specific information”. For example, the mappings (associations) between the entry 320 (in the seating area data store 300) corresponding to the first seating area 130 and entries of the bathing unit component data store 302 (and/or the entries of the operational settings data store 304 and the spa experience data store 306) may allow the controller 160 and/or the control panel 162 to control at least one of (a) the operational settings of the first set of bathing unit components mapped to the first seating area 130 and (b) the specific spa experience at the first seating area 130. Similarly, the mappings (associations) between the entry 322 corresponding to the second seating area 132 and entries of the bathing unit component data store 302 (and/or the entries of the operational settings data store 304 and the spa experience data store 306) may allow the controller 160 and/or the control panel 162 to control at least one of (a) the operational settings of the second set of bathing unit components mapped to the second seating area 132 and (b) the specific spa experience at the second seating area 132. Further still, the mappings (associations) between the entry 326 corresponding to the fourth seating area 136 and entries of the bathing unit component data store 302 (and/or the entries of the operational settings data store 304 and the spa experience data store 306) may allow the controller 160 and/or the control panel 162 to control at least one of (a) the operational settings of the fourth set of bathing unit components mapped to the fourth seating area 136 and (b) the specific spa experience at the fourth seating area 136.

In this manner, mapping information associating entries in the seating area data store 300 to entries in the bathing unit component data store 302 (alone or in combination with the entries in the operational settings data store 304 and the spa experience data store 306) allows a user to achieve desired settings in connection with a selected seating area at least in part by controlling operational settings for the set of bathing unit components mapped to the selected seating area. The mapping information for a particular seating area of the two or more seating areas 131 (e.g., the seating area specific information) also allow the controller 160 (alternatively or additionally, the remote server 165, the control panel 162, and/or the user device 167) to derive and retrieve the set of bathing unit components associated with that particular seating area.

The program memory 254 stores various blocks of code (alternatively called processor-executable instructions and/or computer-executable instructions), for directing the local processor 250 to perform various processes, such as a select seating area process 500, an operate bathing unit components process 550, and an adapt user interface process 600 as described below. The program memory 254 may also store database management system codes for managing the data stores in the storage memory 252 and user interface codes 301 for directing the local processor 250 to modify a user interface associated with the control panel 162 and/or the user device 167. In other embodiments, the program memory 254 may store fewer, additional or alternative codes directing the local processor 250 to execute additional or alternative processes. The storage memory 252 and the program memory 254 may each be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The local processor 250 is generally configured to: (a) execute instructions stored in the program memory 254 (including the user interface codes 301, the select seating area process 500, the operate bathing unit components process 550 and the adapt user interface process 600 as described below), and (b) retrieve information from, and store information into, the data stores (including the seating area data store 300, the bathing unit component data store 302, the operational settings data store 304, the spa experience data store 306 and the user preferences data store 308) of the storage memory 252. The local processor 250 may further be configured to receive information and/or power from, and transmit command signals and/or power to, one or more of the bathing unit components 104, the power source 168, the control panel 162, the user device 167 and the remote server 165 via the I/O interface 256.

### Remote Server 165

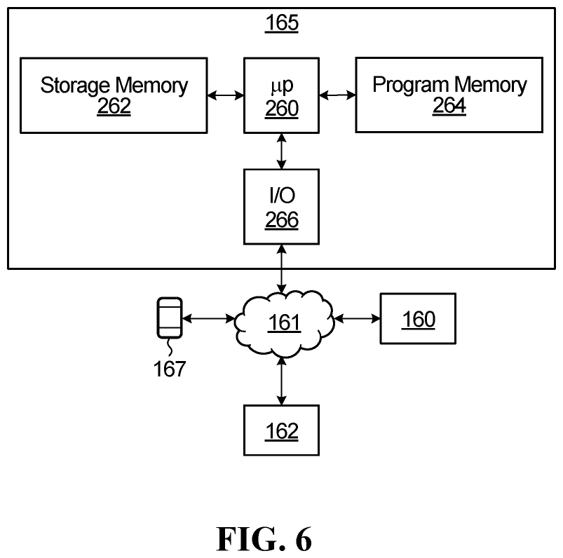

In the embodiment shown in FIG. 6, the remote server 165 includes at least one remote processor 260, a storage memory 262, a program memory 264 and a I/O interface 266, all in communication with the remote processor 260. Other embodiments of the remote server 165 may include fewer, additional or alternative components. The remote processor 260, the storage memory 262, the program memory 264 and the I/O interface 266 may be similar to, respectively, the local processor 250, the storage memory 252, the program memory 254 and the I/O interface 256 of the controller 160. Additionally, although only a single remote processor 260, a single storage memory 262, a single program memory 264 and a single I/O interface 266 is shown in FIG. 6, other embodiments of the remote server 165 may include more than one of each of these components. For example, the remote server 165 may include at least one first remote server hosted at a first data centre configured to perform some functions of the remote server 165 and at least one second remote processor server hosted at a second data centre configured to perform some other functions of the remote server 165.

The I/O interface 266 includes an interface for the remote processor 260 to communicate commands to, and receive information from, the controller 160 (e.g., the local processor 250 of the controller 160) via the wireless network 161. In certain embodiments, the I/O interface 266 may further include a communication module which enables the remote processor 260 to communicate with one or more of (a) the user device processor 280 of the user device 167 (e.g., over the wireless network 161), (c) the panel processor 270 of the control panel 162 (e.g., over the wireless network 161), and (c) directly with the bathing unit components 104.

The storage memory 262 stores information received or generated by the remote processor 260 and may generally function as an information or data store. For example, the storage memory 262 may store a corresponding remote version of the seating area data store 300, the bathing unit component data store 302, the operational settings data store 304, the spa experience data store 306 and/or the user preference data store 308. In other embodiments, the storage memory 262 may include fewer, additional or alternative data stores. The program memory 264 stores various blocks of code (alternatively called processor-executable instructions and/or computer-executable instructions), for directing the remote processor 260 to perform various processes. For example, the storage memory 264 may store a corresponding remote version of the user interface codes 301, the select seating area process 500, the operate bathing unit components process 550 and the adapt user interface process 600. The remote version of the data stores and the blocks of code in the storage memory 262 and the program memory 264 of the remote server 165 may be fully or partially synchronized with the local version of the data stores and the blocks of code in the storage memory 252 and the program memory 254 of the controller 160, or may be fully or partially different from these local versions.

The remote processor 260 is generally configured to execute instructions stored in the program memory 264 (including the user interface codes 301, the select seating area process 500, the operate bathing unit components process 550 and the adapt user interface process 600 as described below) and to retrieve information from, and store information into, the data stores (including the seating area data store 300, the bathing unit component data store 302, the operational settings data store 304, the spa experience data store 306 and/or the user preference data store 308) of the storage memory 262. The remote processor 260 may perform such various processes and store such information in addition to, as a redundancy for, or as an alternative to, the local processor 250 of the controller 160. In this regard, the remote processor 260 may have greater processing power and processing speed when compared to the local processor 250, and may perform certain steps of the various processes faster than the local processor 250.

### Topside Control Panel 162

As described above, the control panel 162 provide an user interface allowing the user to control various operational settings the various bathing unit components 104, including operating the various bathing unit components 104 (e.g., the at least one pump 140, the at least one diverter component 142, the at least one air blower 143, the at least one light 150, the at least one speaker 152, the at least one visual display 154, the at least one temperature change component 146 and the at least one sensor 148) described above according to the different operational modes described above. Consequently, the phrase “operational settings” as used herein is intended to cover operational settings for any bathing unit component 104 of the bathing unit system 100 that can be operated by a user.

The control panel 162 may further provide a user interface through which a user can navigate and be presented with a set of selectable spa experience options, wherein each spa experience is associated with a respective set of operational setting for different bathing unit components, each set corresponding to a respective desired spa experience (or ambience) for the bathing unit system 100. Upon selection of one of the spa experience options, the bathing unit system 100 applies corresponding operational settings to various different bathing unit components 104 in the bathing unit system 100 in order to implement the corresponding spa experience. In this regard, different examples for implementing a spa experience or ambience are described in related U.S. Pat. No. 8,644,960 entitled “METHOD AND SYSTEM FOR PROVIDING AMBIANCE SETTINGS IN A BATHING SYSTEM”, filed on Oct. 22, 2010, the contents of which are incorporated herein by reference.

Further, the controller 160 may be operable to receive at least one command signal from the control panel 162 indicating user selection of a particular seating area of the two or more seating areas, for controlling different operational settings of a set of bathing unit components mapped to the selected seating area, and for controlling a specific spa experience in connection with the selected seating area. For the purpose of simplicity and conciseness, while the control panel 162 may provide many different functions, the description will focus on the functionality and components pertaining to allowing a user to control operational settings for a set of bathing unit components mapped to a selected seating area of the two or more seating areas 131. It is to be understood that such functionality may be provided instead of, or in combination with, other functionality in the control panel 162 through suitable software and hardware components as will become apparent to one skilled in the art in view of the description.

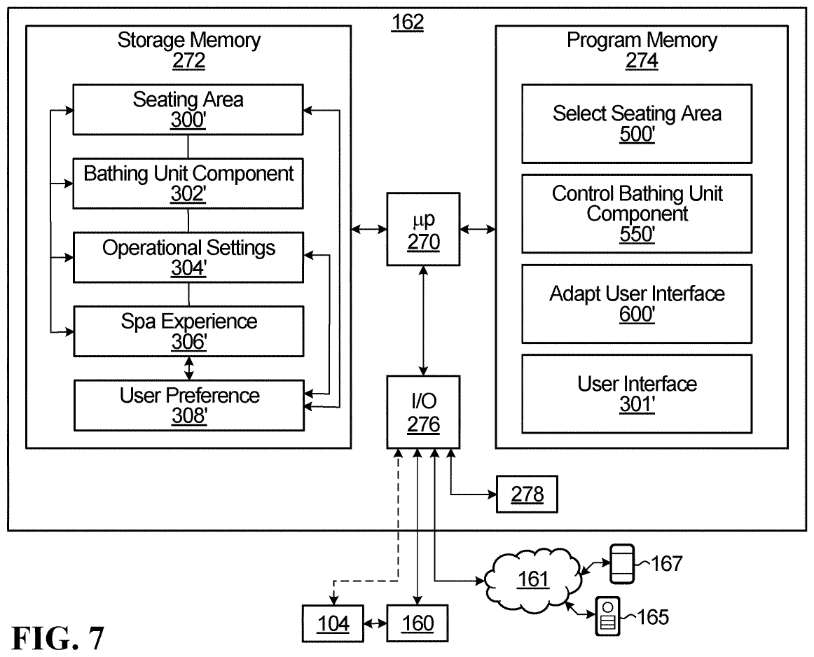

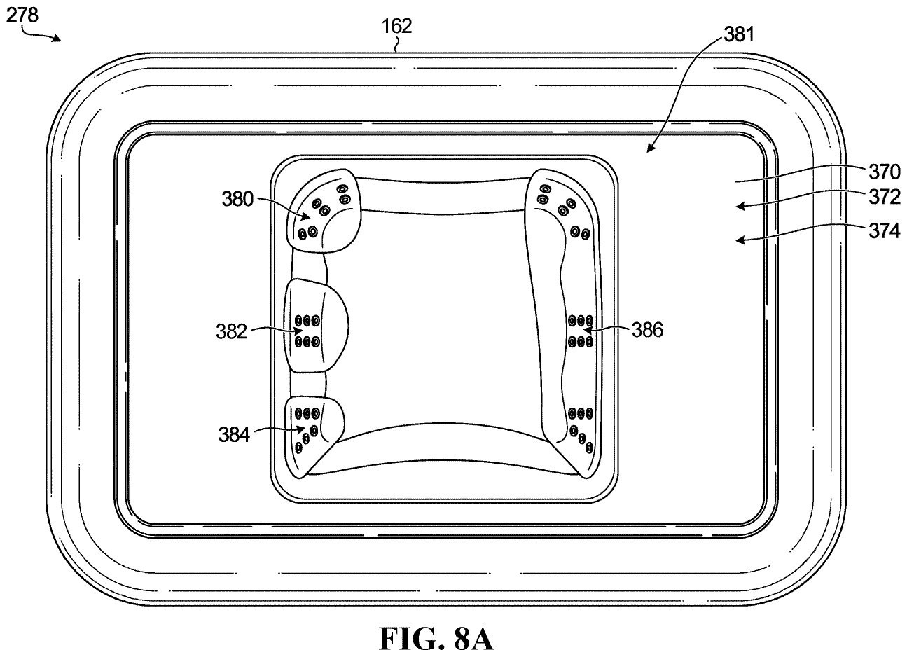

In the embodiment shown in FIG. 7, the topside control panel 162 includes at least one panel processor 270, a storage memory 272, a program memory 274, an I/O interface 276, and at least one user interface 278 all in communication with the panel processor 270. Other embodiments of the control panel 162 may include fewer, additional or alternative components. Additionally, although only a single panel processor 270, a single storage memory 272, a single program memory 274 and a single I/O interface 256 is shown in FIG. 7, other embodiments of the control panel 162 may include more than one of each of these components.

The I/O interface 276 includes an interface for the panel processor 270 to communicate commands to, and receive information from, the local processor 250 the controller 160 via the wired connection 163 or the wireless network 161. In certain embodiments, the I/O interface 276 may further include a communication module which enables the panel processor 270 to communicate directly with one or more of (a) the user device processor 280 of the user device 167 (e.g., over the wireless network 161), (b) the remote processor 260 of the remote server 165 (e.g., over the wireless network 161), and (c) directly with the bathing unit components 104 (e.g., over the wireless network 161).

The storage memory 272 stores information received or generated by the panel processor 270 and may generally function as an information or data store. In the embodiment shown, the storage memory 272 may store a corresponding panel version of the seating area data store 300′, the bathing unit component data store 302′, the operational settings data store 304′, the spa experience data store 306′and/or the user preference data store 308′. In other embodiments, the storage memory 272 may include fewer, additional or alternative data stores. The program memory 274 stores various blocks of code (alternatively called processor-executable instructions and/or computer-executable instructions), for directing the panel processor 270 to perform various processes. In the embodiment shown, the storage memory 274 may store a corresponding panel version of the user interface codes 301′, the select seating area process 500′, the operate bathing unit components process 550′and the adapt user interface process 600′. In particular, the user interface codes 301″ may direct the panel processor 270 to display a graphical user interface (GUI) allowing a user to select a particular seating area from amongst the two or more seating areas 131 utilizing the user interface 278 of the control panel 162. In other embodiments, the program memory 274 may store fewer, additional or alternative codes directing the panel processor 270 to execute additional or alternative processes. The panel version of the data stores and the blocks of code in the storage memory 272 and the program memory 274 of the control panel 162 may be fully or partially synchronized with the local version of the data stores and the blocks of code in the storage memory 252 and the program memory 254 of the controller 160, or may be fully or partially different from these local versions.

The user interface 278 of the control panel 162 may include at least one user input device 370 alone or in combination with at least one display screen 372. As briefly described above, referring to FIGS. 8A and 8B, in some embodiments, the at least one user input device 370 and the at least one display screen 372 comprises combined a touch or presence-sensitive assembly 374 for both displaying the GUI as per the user interface codes 301 (the phrase “user interface codes 301” as used herein include without limitation the user interface codes 301 of the controller 160, the user interface codes 301 of the remote server 165, the user interface codes 301′of the control panel 162 and/or the user interface codes 301′of the user device 167). In this regard, the user interface 278 may be similar to various embodiments of the control panel described in related U.S. Pat. No. 10,353,499, titled “TOPSIDE CONTROL PANEL FOR BATHING UNIT SYSTEM”, filed on Mar. 19, 2018, the contents of which are incorporated by reference herein.

In the embodiment shown in FIG. 8A, the user interface codes 301 may direct the panel processor 270 of the control panel 162 to display, on the assembly 374, a selectable visual representation 381 of the receptacle 106 showing each seating area of the two or more seating areas 131 spatially oriented relative to other seating areas. For example, the selectable visual representation 381 may comprise a model, photograph or schematic representation of an actual physical structure of the receptacle 106, showing the relative orientation of each of the first, second, third and fourth seating areas 130, 132, 134 and 136 relative to each other. In some embodiments, the selectable visual representation 381 may be rotated, enlarged or reduced by the user interacting with the assembly 374. Each seating area depicted in the selectable visual representation 381 may be independently selectable by a user touching or otherwise interacting with a selectable portion of the selectable visual representation 381 corresponding to that seating area. For example, in the embodiment shown in FIG. 8A, a user may touch or otherwise interact with: a first selectable portion 380 of the selectable visual representation 381 to select the first seating area 130; a second selectable portion 382 to select the second seating area 132; a third selectable portion 384 to select the third seating area 134; and a fourth selectable portion 386 of the selectable visual representation 381 to select the fourth seating area 136.

In the embodiment shown in FIG. 8B, the user interface codes may instead direct the assembly 374 to display a plurality of icons 391, whereby an icon of the plurality of icons 391 correspond to a seating area of the two or more seating areas 131. The plurality of icons 391 may differ from the selectable visual representation 381 by not corresponding to the actual physical structure of the receptacle 106, and may have a schematic, rotary or list format for example. The plurality of icons 391 may be accompanied by a static visual representation 393 representing the actual physical structure of the receptacle 106 and the spatial orientation of each seating area of the two or more seating areas 131 relative to each other; however, some embodiments may not include the static visual representation 393. The static visual representation 393 may not have any portion which may be directly interacted with by the user. Each seating area of the plurality of seating areas may be independently selectable by a user touching or otherwise interacting with an icon of the plurality of icons 391 via the assembly 374. In the embodiment shown in FIG. 8B, a user may touch or otherwise interact with: a first selectable icon 390 of the plurality of icons 391 in order to select the first seating area 130; a second selectable icon 392 in order to select the second seating area 132; a third selectable icon 394 to select the third seating area 134; and a fourth selectable icon 396 to select the fourth seating area 136.

In other embodiments, referring to FIGS. 9A, 9B, 9C and 9D, the at least one user input device 370 may instead comprise a physical or mechanical actuator, such as a physical switch 400 shown in FIG. 9A, a keypad 402 shown in FIG. 9B, a physical rotary dial 404 shown in FIG. 9C, and/or an alternative keypad 406 with an overlay 407 shown in FIG. 9D, for receiving user inputs and selections. In some embodiments, the physical actuator may be accompanied by the display screen 372 for displaying the user selectable options associated with the physical actuator; however, some embodiments may not include the display screen 372 and may include the static visual representation 393 of the receptacle 106 or may not include any visual representation of the receptacle 106.

In the embodiment shown in FIG. 9A, the physical switch 400 includes a plurality of positions 411, whereby a position of the plurality of positions 411 correspond to a seating area of the two or more seating areas 131. In the embodiment shown, the physical switch 400 is accompanied by the static visual representation 393 of the receptacle 106 representing the actual physical structure of the receptacle 106 and/or the spatial orientation of each seating area of the two or more seating areas 131 relative to each other; however, some embodiments may not include the static visual representation 393. Each position may be selectable by a user actuating the physical switch 400 to that position. In the embodiment shown in FIG. 9A, a user may actuate the physical switch 400 to: a first position 410 of the plurality of positions 411 in order to select the first seating area 130; a second position 412 in order to select the second seating area 132; a third position 414 to select the third seating area 134; and a fourth position 416 to select the fourth seating area 136.

In the embodiment shown in FIG. 9B, the keypad 402 includes a plurality of keys 421, whereby one or more keys of the plurality of keys 421 may be selected to select a seating area of the two or more seating areas 131. In the embodiment shown, the keypad 402 is accompanied by the display screen 372 which may be controlled by the user interface codes 301 to display the static visual representation 393 of the receptacle 106 and/or various menus for selecting the seating area and for activating, deactivating and controlling operation of one or more bathing unit components of the plurality of bathing unit components 104. In the embodiment shown in FIG. 9B, the plurality of keys 421 includes a respective key actuatable by a user to select a particular seating area of the two or more seating areas 131, including: a first key 420 actuatable to select the first seating area 130; a second key 422 actuatable to select the second seating area 132; a third key 424 actuatable to select the third seating area 134; and a fourth key 426 actuatable to select the fourth seating area 136. However, in other embodiments, the plurality of keys 421 may include a different combination of keys (e.g., up key, down key, enter key, cancel key, menu key, etc.) which may be used in combination with the menus displayed on the display screen 372 to select a particular seating area and to activate, deactivate and control operation of one or more bathing unit components.

In the embodiment shown in FIG. 9C, the rotary dial 404 includes a rotatable and depressible actuator 431 which may be rotated and depressed to select a seating area of the two or more seating areas 131. In the embodiment shown, the rotary dial 404 is accompanied by the display screen 372 which may be controlled by the user interface codes 301 to display the static visual representation 393 of the receptacle 106, the selectable visual representation 381 of the receptacle 106 and/or a plurality of menus for selecting the seating area and for activating, deactivating and controlling operation of one or more bathing unit components of the plurality of bathing unit components 104. In this regard, the rotary dial 404 to be similar to various embodiments of the topside control panel described in related U.S. application Ser. No. 17/515703, titled “TOPSIDE CONTROL PANEL AND TOPSIDE CONTROL PANEL SYSTEM FOR BATHING UNIT SYSTEM AND METHOD OF OPERATING THE SAME”, filed on Nov. 1, 2021, the contents of which are incorporated by reference herein. In the embodiment shown in FIG. 9C, a user may use the actuator 431 to cycle through the plurality of menus to arrive at a seating area selection menu 433 including: a first selectable option 430 selectable to select the first seating area 130; a second selectable option 432 selectable to select the second seating area 132; a third selectable option 434 selectable to select the third seating area 134; and fourth selectable seating option 436 selectable to select the fourth seating area 136. The seating area selection menu 433 further displays the static visual representation 393 of the receptacle 106. The rotary dial 404 may allow a user to more easily select a seating area, particularly when the user is in the receptacle 106 and may have wet hands due to the water 108.

In the embodiment shown in FIG. 9D, the keypad 406 includes a plurality of keys 491 which may be selected to select a seating area of the two or more seating areas 131. The overlay 407 may overlay (or be associated with) at least some keys of the plurality of keys 491. The overlay 407 may display representations of the two or more seating areas 131 in a manner similar to the static visual representation 393 shown in FIGS. 8B, 9A, 9B and 9C, and may represent the actual physical structure of the receptacle 106 and the spatial orientation of each seating area of the two or more seating areas 131 relative to each other. In the embodiment shown in FIG. 9D, the plurality of keys 491 includes a respective key actuatable by a user to select a particular seating area of the two or more seating areas 131, including: a first key 490 actuatable to select the first seating area 130; a second key 492 actuatable to select the second seating area 132; a third key 494 actuatable to select the third seating area 134; and a fourth key 496 actuatable to select the fourth seating area 136. The overlay 407 may include a first portion 493 visually representing the first seating area 130 and overlaying (or otherwise associated with) the first key 490; a second portion 495 visually representing the second seating area 132 and overlaying the second key 492; a third portion 497 visually representing the third seating area 134 and overlaying the third key 494; and a fourth portion 499 visually representing the fourth seating area 136 and overlaying the fourth key 496. The combination of the plurality of keys 491 and the overlay 407 may allow a user to more easily select a seating area, and more quickly discern which seating area is being selected, particularly when the user is in the receptacle 106 and may have wet hands due to the water 108. In the embodiment shown in FIG. 9D, the control panel 162 may further include additional keys (e.g., up key, down key, enter key, cancel key, menu key, etc.) and the display screen 372, which may be used in combination with the plurality of keys 491 and the overlay 407 to select a particular seating area and to activate, deactivate and control operation of one or more bathing unit components of the plurality of bathing unit components 104.

Many other examples of the at least one user interface 278 of the control panel 162 are possible and will become apparent to one skilled in the art after reading of the present descriptions. The nature of the user input device 370, and therefore the nature of the type of user input performed by the user at the control panel 162, may differ in different implementations.

The panel processor 270 is generally configured to execute instructions stored in the program memory 274 (including the user interface codes 301′, the select seating area process 500′, the operate bathing unit component process 550′and the adapt user interface process 600′as described below) and to retrieve information from, and store information into, the data stores (including the seating area data store 300′, the bathing unit component data store 302′, the operational settings data store 304′, the spa experience data store 306′and/or the user preference data store 308′) of the storage memory 272. The panel processor 270 may perform such various processes and store such information in addition to, as a redundancy for, or as an alternative to, the local processor 250 of the controller 160. In this regard, the panel processor 270 may be particularly adapted for executing the user interface codes 301 to display and to adapt a GUI displayed on the user interface 278 associated with the control panel 162.

### At Least One User Device 167

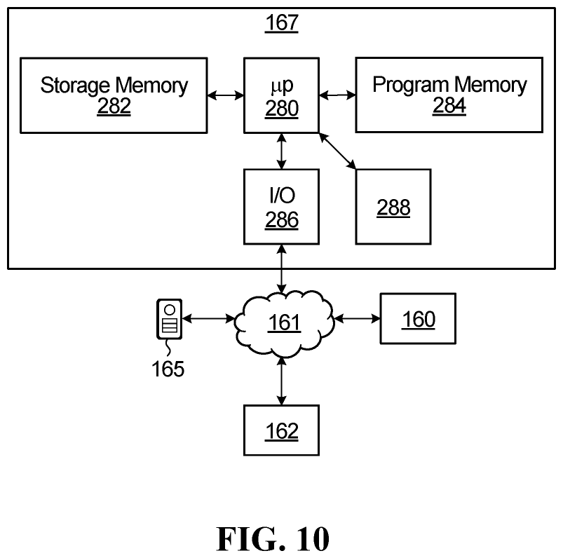

The controller 160 may further be operable to receive at least one command signal from the user device 167 (in addition to or as an alternative to the at least one command signal from the topside control panel 162) indicating user selection of a particular seating area of the two or more seating areas, for controlling different operational settings of a set of bathing unit components mapped to the selected seating area, and for controlling a specific spa experience in connection with the selected seating area. In the embodiment shown in FIG. 10, the user device 167 may include at least one user device processor 280, a storage memory 282, a program memory 284, a I/O interface 286, and at least one user interface 288 all in communication with the user device processor 280. Other embodiments of the user device 167 may include fewer, additional or alternative components.

The I/O interface 286 includes an interface for the user device processor 280 to communicate commands to, and receive information from, the local processor 250 of the controller 160 via the wireless network 161. In certain embodiments, the I/O interface 286 may further include a communication module which enables the user device processor 280 to communicate directly with one or more of (a) the panel processor 270 of the control panel 162 (e.g., over the wireless network 171), (b) the remote processor 260 of the remote server 165, (e.g., over the wireless network 161), and (c) directly with the bathing unit components 104 (e.g., over the wireless network 161).

The storage memory 282 stores information received or generated by the user device processor 280 and may generally function as an information or data store. In the embodiment shown, the storage memory 282 may store a corresponding user device version of the seating area data store 300′, the bathing unit component data store 302′, the operational settings data store 304′, the spa experience data store 306′and/or the user preference data store 308′. In other embodiments, the storage memory 282 may include fewer, additional or alternative data stores. The program memory 284 stores various blocks of code (alternatively called processor-executable instructions and/or computer-executable instructions), for directing the user device processor 280 to perform various processes. In the embodiment shown, the storage memory 282 may store a corresponding user device version of the user interface codes 301′, the select seating area process 500′, the operate bathing unit components process 550′and the adapt user interface process 600′. In particular, the user interface codes 301′may direct the device processor 280 to display a GUI allowing a user to select a particular seating area from amongst the two or more seating areas 131 utilizing the user interface 288 of the user device 167. In other embodiments, the program memory 284 may store fewer, additional or alternative codes directing the device processor 280 to execute additional or alternative processes. The panel version of the data stores and the blocks of code in the storage memory 282 and the program memory 284 of the user device 167 may be fully or partially synchronized with the local version of the data stores and the blocks of code in the storage memory 252 and the program memory 254 of the controller 160, or may be fully or partially different from these local versions.

The user interface 288 of the user device 167 may include at least one user input device 450 and at least one display screen 452. In some embodiments, the user device 167 comprises a personal smart phone or computer tablet and the at least one user input device 450 and the at least one display screen 452 comprises a combined a touch or presence-sensitive assembly for both displaying the GUI and for receiving user inputs and selections. In this regard, the user interface 288 may be similar to various embodiments described in related U.S. Pat. No. 11,455,092 , titled “METHOD AND SYSTEM FOR MONITORING AND CONTROLLING OPERATIONAL SETTINGS IN A BATHING SYSTEM”, filed on Oct. 19, 2022, the contents of which are incorporated by reference herein. In other embodiments, the user device comprises a personal computer, and the user input device 450 may comprise a keyboard and a mouse and the at least one display screen 452 may comprise a standard liquid-crystal display (LCD) display screen.

In the embodiment shown in FIG. 11A, the user interface codes 301 may direct the device processor 280 of the user device 167 to display, on the display screen 452, a selectable visual representation 381′of the receptacle 106 showing each seating area of the two or more seating areas 131 spatially oriented relative to each other (e.g., in a manner similar to the selectable visual representation 381 shown in FIG. 8A). In this regard, the selectable visual representation 381′ may comprise a model, photograph or schematic representation of the actual physical structure of the receptacle 106, and may be rotated, enlarged or reduced by the user interacting with the selectable visual representation 381′via the user input device 450. Each seating area depicted in the selectable visual representation 381′may be selectable by a user touching or otherwise interacting with the selectable portion of the selectable visual representation 381′corresponding to that seating area. For example, in the embodiment shown in FIG. 11A, a user may touch or otherwise interact with: a first selectable portion 380′of the selectable visual representation 381′to select the first seating area 130; a second selectable portion 382′to select the second seating area 132; a third selectable portion 384′to select the third seating area 134; and a fourth selectable portion 386′to select the fourth seating area 136.

In the embodiment shown in FIG. 11B, the user interface codes 301 may direct the device processor 280 of the user device 167 to display, on the display screen 452, the plurality of icons 391′, whereby an icon of the plurality of icons 391′corresponds to a seating area of the two or more seating areas 131 (e.g., in a manner similar to the plurality of icons 391 shown FIG. 8B). The plurality of icons 391′may be accompanied by a static visual representation 393′representing the actual physical structure of the receptacle 106 (e.g., in a manner similar to the static visual representation 393 shown in FIG. 8B). Each icon may be selectable by a user touching or otherwise interacting with the icon via the user input device 450. In the embodiment shown in FIG. 11B, a user may touch or otherwise interact with: a first selectable icon 390′to select the first seating area 130; a second selectable icon 392 to select the second seating area 132; a third selectable icon 394 to select the third seating area 134; and a fourth selectable icon 396 to select the fourth seating area 136.

The device processor 280 is generally configured to execute instructions stored in the program memory 284 (including the user interface codes 301′, the select seating area process 500′, the operate bathing unit components process 550′and the adapt user interface process 600′as described below) and to retrieve information from, and store information into, the data stores (including the seating area data store 300′, the bathing unit component data store 302′, the operational settings data store 304′, the spa experience data store 306′and/or the user preference data store 308′) of the storage memory 282. The device processor 280 may perform such various processes and store such information in addition to, as a redundancy for, or as an alternative to, the local processor 250 of the controller 160. In this regard, the device processor 280 may be particularly adapted for executing the user interface codes 301 to display and to adapt a GUI displayed on the user interface 288 associated with the user device 167.

### Select Seating Area Process 500

The select seating area process 500 may include codes directing the controller 160 and/or the control panel 162 to wait to receive a seat selection signal indicating that a user has selected a seating area of the two or more seating areas 131. A user may generate a seat selection signal in a variety of different ways.

For example, in embodiments of the bathing unit system 100 including the control panel 162, a user may interact with the user interface 278 of the control panel 162 to select a seating area of the two or more seating areas 131. As a more specific example, in embodiments where the control panel 162 comprises the assembly 374, the user may interact with assembly 374 to select the first, second, third or fourth selectable portions 380, 382, 384 or 386 of the selectable visual representation 381 (shown in FIG. 8A) or alternatively the first, second, third or fourth selectable icons 390, 392, 394 or 396 of the plurality of icons 391 (shown in FIG. 8B) presented on the assembly 374 to select a corresponding one of the first, second, third and fourth seating areas 130, 132, 134 or 136. Additionally or alternatively, in embodiments where the control panel 162 is or comprises the user device 167, the user may instead interact with the user input device 450 to select the first, second, third or fourth selectable portions 380′, 382′, 384′or 386′of the selectable visual representation 381′ (shown in FIG. 11A) or alternatively, the first, second, third or fourth selectable icons 390′, 392′, 394′or 396′of the plurality of icons 391′(shown in FIG. 11B)) presented on the display screen 452 to select a corresponding one of the first, second, third and fourth seating areas 130, 132, 134 or 136.

Alternatively, in embodiments where the control panel 162 is or comprises the physical switch 400, the user may actuate the physical switch 400 to the first, second, third or fourth positions 410, 412, 414 or 416 of the plurality of positions 411 (shown in FIG. 9A) to select a corresponding one of the first, second, third and fourth seating areas 130, 132, 134 or 136. As a further alternative, in embodiments where the control panel 162 is or comprises the keypad 402, the user may actuate the plurality of keys 421 (shown in FIG. 9B) to select a corresponding one of the first, second, third or fourth seating areas 130, 132, 134 or 136. As a further alternative, in embodiments where the control panel 162 is or comprises the rotary dial 404, the user may rotate and depress the actuator 431 to arrive at the seating area selection menu 433 and to select the first, second, third or fourth selectable options 430, 432, 434 or 436 (shown in FIG. 9C) to select a corresponding one of the first, second, third or fourth seating areas 130, 132, 134 or 136. As a further alternative, in embodiments where the control panel 162 is or comprises the keypad 406, the user may actuate the plurality of keys 491 (shown in FIG. 9D) to select a corresponding one of the first, second, third or fourth seating areas 130, 132, 134 or 136.

As a further alternative, in embodiments of the bathing unit system 100 including the at least one sensor 148 which senses occupancy of different seating areas of the two or more seating areas 131, a user may instead occupy the seating area to select the seating area. For example, some embodiments of the bathing unit system 100 include the first, second, third and fourth sensors 240, 242, 244, and 246 which comprise occupancy sensors and which are associated with the first, second, third and fourth seating areas 130, 132, 134 and 136. The first, second, third and fourth sensors 240, 242, 244, and 246 may generate an “occupied” signal in response to a user occupying a corresponding seating area to indicate a user selection of the corresponding seating area. For example, the occupancy sensors 240, 242, 244 and 246 may comprise a weight sensor on or proximate the corresponding seating area which transmits the “occupied” signal when a weight (e.g., a user) is placed on the seating area. As an additional example, the occupancy sensors 240, 242, 244 and 246 may instead comprise motion sensors on or proximate the corresponding seating area which transmits the “occupied” signal when motion is detected around the corresponding seating area. As a further additional example, the occupancy sensors 240, 242, 244 and 246 may instead comprise proximity sensors on or proximate the corresponding seating area which transmits the “occupied” signal when a corresponding sensor (e.g., in the user device 167, or an auxiliary device associated with the user) is placed within a certain range (e.g., 10 cm to 1 m) of the proximity sensor. In such embodiments, the seat selection signal comprises an “occupied” signal generated by one or more of the occupancy sensors 240, 242, 244 and 246.

As a further alternative, in embodiments of the bathing unit system 100 including the at least one sensor 148 which senses user interaction (other than interaction with the user interface 278 of the control panel 162 or the user interface 288 of the user device 167), the user may provide another type of user interaction to select a seating area of the two or more seating areas 131. For example, some embodiments of the at least one sensor 148 may comprise the at least one microphone configured to detect the user interaction comprising a voice command conveying user selection of a seating area of the two or more seating areas 131. The voice command may be “select seat 1” or “select top right seat”. One skilled in the art will appreciate that alterative embodiments may include additional or alternative voice commands. As a further example, some embodiments of the at least one sensor 148 may comprise at least one camera configured to detect a user interaction comprising a movement command conveying user selection of the seating area. The movement command may involve a user pointing to a particular seating area in space or may involve a user touching the water 108 in the receptacle 106 proximate a particular seating area. One skilled in the art will appreciate that alterative embodiments may include additional or alternative movement commands.

Additionally, other variants and embodiments for detecting a user selection of a seating area of the two or more seating areas 131 will become evident to one skilled in the art in view of the present description. Once the controller 160 and/or the control panel 162 receives the seat selection signal indicating that the user has selected a seating area, the controller 160 and/or the control panel 162 may then proceed to one or more of the operate bathing unit components process 550 and/or the adapt user interface process 600 described below.

### Operate Bathing Unit Components Process 550

The operate bathing unit components process 550 may direct the controller 160 and/or the control panel 162 to perform various processes to activate, deactivate and otherwise control the operation of a set of bathing unit components mapped to (associated with) a particular seating area in response to receiving the seat selection signal indicating that the user has selected that seating area. In this regard, the operate bathing unit components process 550 may specifically direct the controller 160 and/or the control panel 162 to generate command signals for controlling the operational settings of the set of bathing unit components mapped to (associated with) the selected seating area and/or the specific spa experience at the selected seating area.

For example, in response to the user selecting the first seating area 130 (e.g., using the user interface 278 (of the control panel 162) and/or the user interface 288 (of the user device 167), and in particular by interacting with the first selectable portion 380 in FIG. 8A, interacting with the first selectable icon 390 in FIG. 8B, actuating the physical switch 400 to the first position 410 in FIG. 9A, interacting with the first key 420 in FIG. 9B, interacting with the first selectable option 430 in FIG. 9C, interacting with the first key 490 in FIG. 9D, interacting with the first selectable portion 380′in FIG. 11A or interacting with the first selectable icon 390′in FIG. 11B), the operate bathing unit components process 550 may direct the controller 160 and/or the control panel 162 to generate command signals for operating the first set of bathing unit components mapped to the first seating area 130. More specifically, the operate bathing unit components process 550 may direct the controller 160 and/or the control panel 162 to: (a) retrieve the first set of bathing unit components mapped to the first seating area 130 (e.g., from the mapping between the seating area data store 300 and the bathing unit component data store 302, which may be one or more of the second pump 172, the second diverter valve 182, the first air blower 190, the first set of lights 200, the fourth set of lights 206, the first set of speakers 210 and the first display screen 220 in the embodiment shown in FIGS. 1 and 2) and (b) generate command signals for controlling operational settings of one or more bathing unit components of the first set of bathing unit components. As a more specific example of (b) above, the operate bathing unit components process 550 may direct the controller 160 and/or the control panel 162 to generate control signals for operating the second pump 172 in one of the “on” modes (e.g., one or more of the “low” mode, “standard” mode and “high” mode, which may be retrieved from the operational settings data store 304) and for adjusting the second diverter valve 182 to direct the flow of the water 108 towards the inlet 112 associated with the first seating area 130 (e.g., the “first” position, which may again be retrieved from the operational settings data store 304).

In some embodiments, the second diverter valve 182 may require manual adjustment to the “first” position. In such embodiments, the operate bathing unit components process 550 instead direct the controller 160 and/or the control panel 162 to cause the display screen 372 (of the control panel 162) and/or the display screen 452 (of the user device 167) to display manual adjustment instructions for the second diverter valve 182 to adjust it to the “first” position. The manual adjustment instructions may include a relative location and orientation of the second diverter valve 182 relative to the first seating area 130, as well as an actuation motion (e.g., rotational movement, lateral movement, linear movement, etc.) and an actuation direction (e.g., up, down, left, right, counterclockwise, counterclockwise, etc.) in order to adjust the second diverter valve 182 to the “first” position or any other applicable position.

In contrast, in response to the user selecting the second seating area 132 of the two or more seating areas 131 (e.g., using the user interface 278 (of the control panel 162) and/or the user interface 288 (of the user device 167), and in particular by interacting with the second selectable portion 382 in FIG. 8A, interacting with the second selectable icon 392 in FIG. 8B, actuating the physical switch 400 to the second position 412 in FIG. 9A, interacting with the second key 422 in FIG. 9B, interacting with the second selectable option 432 in FIG. 9C, interacting with the second key 492 in FIG. 9D, interacting with the second selectable portion 382′in FIG. 11A or interacting with the second selectable icon 392′in FIG. 11B), the operate bathing unit components process 550 may instead direct the controller 160 and/or the control panel 162 to generate command signals for operating the second set of bathing unit components mapped to the second seating area 132. More specifically, the operate bathing unit components process 550 may direct the controller 160 and/or the control panel 162 to: (a) retrieve the second set of bathing unit components mapped to the second seating area 132 (e.g., from the mapping between the seating area data store 300 in the bathing unit component data store 302, which may be one or more of the first pump 170, the second pump 172, the first diverter valve 180, the second diverter valve 182, the first air blower 190, the second set of lights 202, the fourth set of lights 206, the first set of speakers 210 and the first display screen 220 in the embodiment shown in FIGS. 1 and 2) and (b) generate command signals for controlling operational settings of one or more bathing unit components of the second set of bathing unit components. As a more specific example of (b) above, the operate bathing unit components process 550 may direct the controller 160 and/or the control panel 162 to generate control signals to automatically operate the first pump 170 in one of the “on” modes (which may be retrieved from the operational settings data store 304), automatically operate the second pump 172 in one of the “on” mode (which may also be retrieved from the operational settings data store 304), automatically adjust the first diverter valve 180 to direct the flow of the water 108 towards the inlet 112 associated with the second seating area 132 (e.g., the “first” position, which may also be retrieved from the operational settings data store 304) and automatically adjust the second diverter valve 182 to direct the flow of the water 108 towards the inlet 112 associated with the second seating area 132 (e.g., the “second” position, which may also be retrieved from the operational settings data store 304). In some embodiments, the first and second diverter valves 180 and 182 may require manual adjustment to the respective “first” and “second” positions; in such embodiments, the operate bathing unit components process 550 may instead direct the controller 160 and/or the control panel 162 to cause the display screen 372 and/or the display screen 452 to display manual adjustment instructions for adjusting the first and second diverter valves 180 and 182 to the appropriate corresponding position.

In some embodiments, instead of simply generating command signals for controlling operational settings of one or more bathing unit components of the set of bathing unit components mapped to a selected seating area, the operate bathing unit components process 550 may instead direct the controller 160 and/or the control panel 162 to generating command signals for implementing a spa experience at the selected seating area by controlling the set of bathing unit components mapped to the selected seating area.

For example, in response to the user selecting the first seating area 130, the operate bathing unit components process 550 may direct the controller 160 and/or the control panel 162 to implement a “default” or a “preferred” spa experience at the first seating area. For example, the operate bathing unit components process 550 may direct the controller 160 and/or the control panel 162 to: (a) retrieve the first set of bathing unit components mapped to the first seating area 130 (e.g., from the mapping between the seating area data store 300 and the bathing unit component data store 302); (b) retrieve the operational settings associated with a particular spa experience (e.g., a “default” experience or a “user preferred” experience from the spa experience data store 306) and (c) generate command signals for implementing the retrieved spa experience at the first seating area 130 by controlling the retrieved first set of bathing unit components. As a more specific example of (b) and (c) above, the operate bathing unit components process 550 may direct the controller 160 and/or the control panel 162 to generate command signals for operating the second pump 172 in the “low” mode for 30 minutes, operating the first air blower 190 in the “off” mode, adjusting the second diverter valve 182 to the “first” position to direct the flow of the water 108 towards the first seating area 130, and to operating the first set of speakers 210 to play relaxing music, in order to implement the “relaxation” experience at the first seating area 130.

In some embodiments, there may be a global “default” experience (e.g., stored in the spa experience data store 306). In such embodiments, the operate bathing unit components process 550 may automatically initiate this “default” experience at each seating area of the two or more seating areas 131 when that seating area is selected. For example, where the global “default” experience is the “relaxation” experience, in response to the user selecting any seating area of the two or more seating areas 131, the operate bathing unit components process 550 may direct the controller 160 and/or the control panel 162 to generate command signals for controlling the set of bathing unit components in order to implement the “relaxation” experience at a selected seating area. For example, in response to the user selecting the second seating area 132, the operate bathing unit components process 550 may direct the controller 160 and/or the control panel 162 to: (a) retrieve the second set of bathing unit components mapped to the second seating area 132 (e.g., from the mapping between the seating area data store 300 and the bathing unit component data store 302); (b) retrieve the operational settings associated with the global “default” experience (e.g., the “relaxation” experience from the spa experience data store 306) and (c) generate command signals for implementing the retrieved operational settings at the second seating area by controlling the retrieved second set of bathing unit components. As a more specific example of (b) and (c) above, the operate bathing unit components process 550 may direct the controller 160 and/or the control panel 162 to generate command signals for operating the first pump 170 and the second pump 172 in the “low” mode, operating the first air blower 190 in the “off” mode, adjusting the first diverter valve 180 to the “first” position, adjusting the second diverter valve 182 to the “second” position, operating the first set of speakers 210 to play relaxing music, all in order to implement the “relaxation”experience at the second seating area 132.

However, in other embodiments, there may instead be a seat-based “default” experience, e.g., the default spa experience at the first seating area 130 may be the “relaxation” experience, whereas the default spa experience at the second seating area 132 may be the “back massage” experience while the default spa experience at the fourth seating area 136 may be the “leg massage” experience. In such embodiments, the operate bathing unit components process 550 may automatically initiate the seat-based “default” experience based on which seating area of the two or more seating areas 131 is selected by the user.

For example, in response to the user selecting the second seating area 132, the operate bathing unit components process 550 may instead direct the controller 160 and/or the control panel 162 to: (a) retrieve the second set of bathing unit components mapped to the second seating area 132 (e.g., from the mapping between the seating area data store 300 and the bathing unit component data store 302); (b) retrieve the operational settings associated with the seat-based “default” experience at the second seating area 132 (e.g., the “back massage” experience from the spa experience data store 306) and (c) generate command signals for implementing the retrieved spa experience at the second seating area 132 by controlling the retrieved second set of bathing unit components. As a more specific example of (b) and (c) above, the operate bathing unit components process 550 may direct the controller 160 and/or the control panel 162 to generate control signals for operating the first pump 170 and the second pump 172 in the “high” mode, operating the first air blower 190 in the “off” mode, adjusting the first diverter valve 180 to the “first” position, adjusting the second diverter valve 182 to the “second” position, and operating the first set of speakers 210 in the “off” mode, all in order to implement the “back massage”experience at the second seating area 132.

In contrast, in response to the user electing the fourth seating area 136, the operate bathing unit components process 550 may instead direct the controller 160 and/or the control panel 162 to: (a) retrieve the fourth set of bathing unit components mapped to the fourth seating area 136 (e.g., from the mapping between the seating area data store 300 and the bathing unit component data store 302, which may be one or more of the third pump 174, the third diverter valve 184, the second air blower 192, the fourth set of lights 206, the second set of speakers 212 and the second display screen 222 in the embodiment shown in FIGS. 1 and 2); (b) retrieve the operational settings associated with the seat-based “default” experience at the fourth seating area 136 (e.g., the “leg massage” experience from the spa experience data store 306) and (c) generate command signals for implementing the retrieved spa experience at the fourth seating area 136 by controlling the retrieved fourth set of bathing unit components. As a more specific example of (b) and (c) above, the operate bathing unit components process 550 may direct the processor 270 and/or the local processor 250 to generate control signals for operating the third pump 174 in the “high” mode, operating the second air blower 192 in the “off” mode, adjusting the third diverter valve 184 to the “third” position to direct the flow of the water 108 towards specific lower inlets 112 of the fourth seating area 136, operating the second set of speakers 212 and the second display screen in the “off” mode, all in order to implement the “leg massage”experience at the fourth seating area 136.

In some embodiments, different combinations of seating areas of the two or more seating areas 131 may be utilized to implement a particular spa experience. For example, in some embodiments, a particular seating area of the two or more seating areas 131 may be equipped particular jets that are better adapted to a “back massage” experience (e.g., the first seating area 130 with the middle inlets 112 associated with the second diverter valve 182 for example) whereas another seating area may be equipped with particular jets that are better adapted to a “leg massage” experience (e.g., the second seating area 132 with the lower inlets 112 associated to the first diverter valve 180 for example). For example, in response to a user selection of the first seating area 130 followed by a user selection of a “leg massage” experience, rather than generating command signals for operating the first set of bathing unit components, the operate bathing unit components process 550 may instead direct the controller 160 and/or the control panel 162 to cause the display screen 372 (of the control panel 162) and/or the display screen 452 (of the user device 167) to display a movement instruction for the user to move to the second seating area 132. The movement instructions may include a relative location of the second seating area relative to the first seating area 130. After the user has moved to the second seating area 132 (e.g., sensed by the occupancy sensor 242 associated with the second seating area 132), the operate bathing unit components process 550 may then direct the controller 160 and/or the control panel 162 to generate command signals for controlling the second set of bathing unit components at the second seating area 132.

Further, in some embodiments, some spa experiences may involve a combination of different spa experiences that are best provided by different specific seating areas (e.g., a “full-body massage” experience being a combination of a “back massage” experience best provided by the inlets 112 associated with the first seating area 130, an “arm massage” experience best provided by the inlets 112 associated with third seating area 134 and a “leg massage” experience best provided by the inlets 112 associated with the second seating area 132). In such embodiments, the operate bathing unit components process 550 may direct the controller 160 and/or the control panel 162 to control the different set of bathing unit components for different seating areas sequentially, and to cause the display screen 372 and/or the display screen 452 to display the movement instruction for the user to move to a particular seating area based on a current phase of the combined spa experience. More specifically, the movement instruction may direct the user to move to the first seating area 130 when the “full-body massage” experience is in the “back massage” experience phase. After the user has moved to the first seating area 130 (e.g., sensed by the occupancy sensor 240 associated with the first seating area 130 or other user input provided via the control panel 162 and/or the user device 167), the operate bathing unit components process 550 may then direct the controller 160 and/or the control panel 162 to generate command signals for controlling the first set of bathing unit components at the first seating area 130. A further movement instruction may direct the user to then move to the second seating area 132 when the “full-body massage” experience is in the “leg massage” experience phase. After the user has moved to the second seating area 132, the operate bathing unit components process 550 may then direct the controller 160 and/or the control panel 162 to generate command signals for controlling the second set of bathing unit components at the second seating area 132. A further movement instruction may direct the user to then move to the third seating area 134 when the “full-body massage” experience is in the “arm massage” experience phase. After the user has moved to the third seating area 134, the operate bathing unit components process 550 may then direct the controller 160 and/or the control panel 162 to generate command signals for controlling the third set of bathing unit components at the third seating area 134.

In yet further embodiments, some spa experiences may involve concurrent combination of different spa experiences that are provided by different specific seating areas (e.g., a “back and leg massage” experience being a combination of a “back massage” experience best provided by the inlets 112 associated with the first seating area 130 and a “leg massage” experience best provided by the inlets 112 associated with the second seating area 132). In such embodiments, the operate bathing unit components process 550 may direct the controller 160 and/or the control panel 162 to concurrently control the first set of bathing unit components associated with the first bathing area 130 and the second set of bathing unit components associated with the second seating area 132. For example, the operate bathing unit components process 550 may direct the controller 160 and/or the control panel 162 to cause the display screen 372 and/or the display screen 452 to display a position instruction for the user to position their back proximate the first seating area 130 and then their legs proximate the second seating area 132. The operate bathing unit components process 550 may then direct the controller 160 and/or the control panel 162 to generate command signals for concurrently controlling both the first set of bathing unit components at the first seating area 130 and the second set of bathing unit components at the second seating area 132.

In yet further some embodiments, the command signals for controlling the operational settings of the set of bathing unit components mapped to a selected seating area and/or the specific spa experience at the selected seating area may be customized based on an identity of the user selecting a particular seating area. For example, the controller 160 and/or the control panel 162 may receive a user identification signal (e.g., from the user device 167, from the user logging into the control panel 162, and/or from the auxiliary user device associated with the user) conveying user identification information corresponding to the user providing the selection of the particular seating area. The auxiliary device may be any suitable device capable of communicating information conveying user identification information such as, for example but without being limited to, a smartphone, a smartwatch, a wearable electronic activity tracker (such as a fitness band) and/or a near-field communication (NFC) or RFID enabled device. As mentioned above, in a specific practical example of implementation, the auxiliary device may be in the form of an RFID or NFC chip implanted in a portion of a user's body (for example in a user's hand, arm, leg or other suitable body part).

The controller 160 and/or the control panel 162 may then retrieve user preference information associated with the user identification information from the user preference data store 308 at least in part by processing the user identification information. For example, the user identification information may comprise a user_ID; the operate bathing unit components process 550 may direct the controller 160 and/or the control panel 162 to retrieve entries associated with that user_ID from one or more of the user preference data store 308, the spa experience data store 306, the operational settings data store 304 and/or the seating area data store 300 in order to retrieve user preference information. The command signals may then be customized based on the retrieved user preference information.

For example, if a particular first user (e.g., John associated with the entry 360 having the user_ID “John” in the user preference data store 308) selects the first seating area 130, and the retrieved user preference information associated with the first user indicates that the first user prefers the “party” experience at the first seating area 130 (e.g., shown in FIG. 5A), the operate bathing unit components process 550 may direct the controller 160 and/or the control panel 162 to implement the “party” experience at the first seating area 130. More specifically, the operate bathing unit components process 550 may direct the controller 160 and/or the control panel 162 to: (a) retrieve the first set of bathing unit components mapped to the first seating area 130; (b) retrieve the operational settings associated with user-specific spa experience at the first seating area (e.g., a “party” experience from the spa experience data store 306 associated with the user_ID “John” and the seating_ID “seat1”) and (c) generate command signals for implementing the retrieved user-specific spa experience at the first seating area 130 by controlling the retrieved first set of bathing unit components. As a more specific example of (b) and (c) above, the operate bathing unit components process 550 may direct the controller 160 and/or the control panel 162 to generate command signals for operating the second pump 172 at the “high” mode, operating the first air blower 190 in the “high” mode, adjusting the second diverter valve 182 to the “first” position, controlling the first set of speakers 210 to play “John's party playlist”, etc.

However, if the same first user selects the second seating area 132, and the retrieved user preference information indicates that the first user prefers the “back massage” experience at the second seating area 132 (e.g., shown in FIG. 5B), the operate bathing unit components process 550 may instead direct the controller 160 and/or the control panel 162 to implement the “back massage” experience at the second seating area 132. More specifically, the operate bathing unit components process 550 may direct the controller 160 and/or the control panel 162 to: (a) retrieve the second set of bathing unit components mapped to the second seating area 132; (b) retrieve the operational settings associated with user-specific spa experience (e.g., a “back massage” experience from the spa experience data store 306 associated with the user_ID “John” and the seat_ID “seat2”) and (c) generate command signals for implementing the retrieved user-specific spa experience at the second seating area 132 by controlling the retrieved second set of bathing unit components. As a more specific example of (b) and (c) above, the operate bathing unit components process 550 may direct the controller 160 and/or the control panel 162 to generate command signals for operating the first pump 170 and the second pump 172 at the “high” mode for 15 minutes and “standard” mode for 2 minutes and then repeat (or any other massage sequence known to one skilled in the art), operating the first air blower 190 in the “off” mode, adjusting the first diverter valve 180 to the “off” position and the second diverter valve 182 to the “second” position to direct the flow of the water 108 towards the upper inlets 112 of second seating area 132 to implement the back massage, and controlling the first set of speakers 210 to play “John's massage playlist”, etc.

In contrast, if a particular second user (e.g., Jane associated with the entry 361 having the user_ID “Jane” in the user preference data store 308) selects the first seating area 130, and the retrieved user preference information associated with the second user indicates that the second user prefers the “relaxation” experience at the first seating area 130 (e.g., shown in FIG. 5A), the operate bathing unit components process 550 may direct the controller 160 and/or the control panel 162 to implement the “relaxation” experience at the first seating area 130. More specifically, the operate bathing unit components process 550 may direct the controller 160 and/or the control panel 162 to: (a) retrieve the first set of bathing unit components mapped to the first seating area 130; (b) retrieve the operational settings associated with user-specific spa experience at the first seating area (e.g., a “relaxation” experience from the spa experience data store 306 associated with the user_ID “Jane” and the seating_ID “seat1”) and (c) generate command signals for implementing the retrieved user-specific spa experience at the first seating area 130 by controlling the retrieved first set of bathing unit components. As a more specific example of (b) and (c) above, the operate bathing unit components process 550 may direct the controller 160 and/or the control panel 162 to generate command signals for operating the second pump 172 at the “standard” mode, operating the first air blower 190 in the “off” mode, adjusting the second diverter valve 182 to the “first” position, controlling the first set of speakers 210 to play “Jane's relaxation playlist”, etc.

### Adapt User Interface Process 600

The adapt user interface process 600 may direct the controller 160 and/or the control panel 162 to perform various processes to adapt the GUI presented on the user interface 278 (of the control panel 162) and/or the user interface 288 (of the user device 167) to present a set of user selectable options customized to a seating area selected by a user, and not to non-selected seating areas of the two or more seating areas 131. The set of user selectable options may then be selected by the user to cause the controller 160 and/or the control panel 162 to generate command signals for controlling the operational settings of the set of bathing unit components mapped to (associated with) the selected seating area and/or the specific spa experience at the selected seating area (e.g., by using the operate bathing unit components process 550 described above).

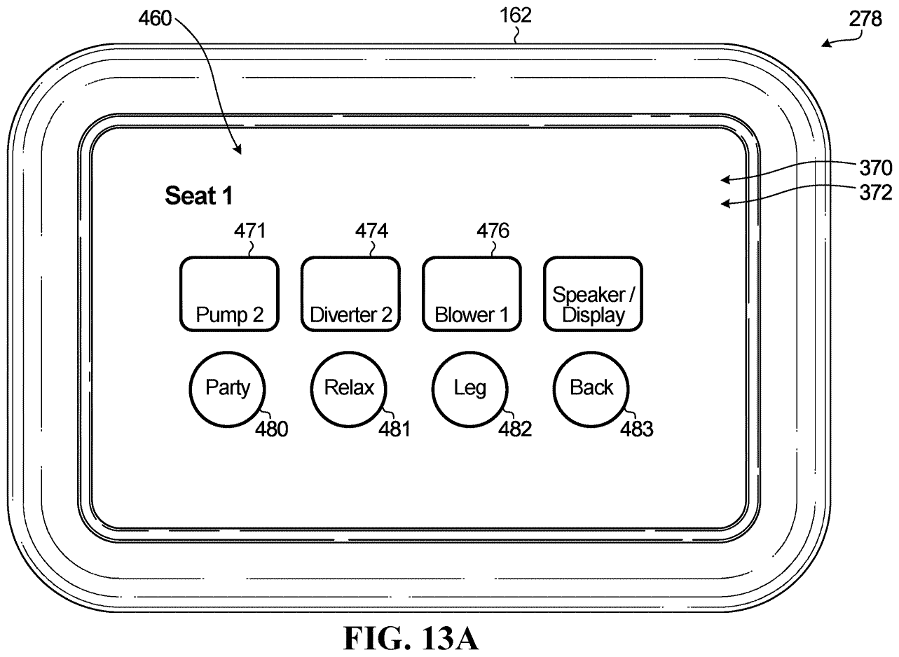

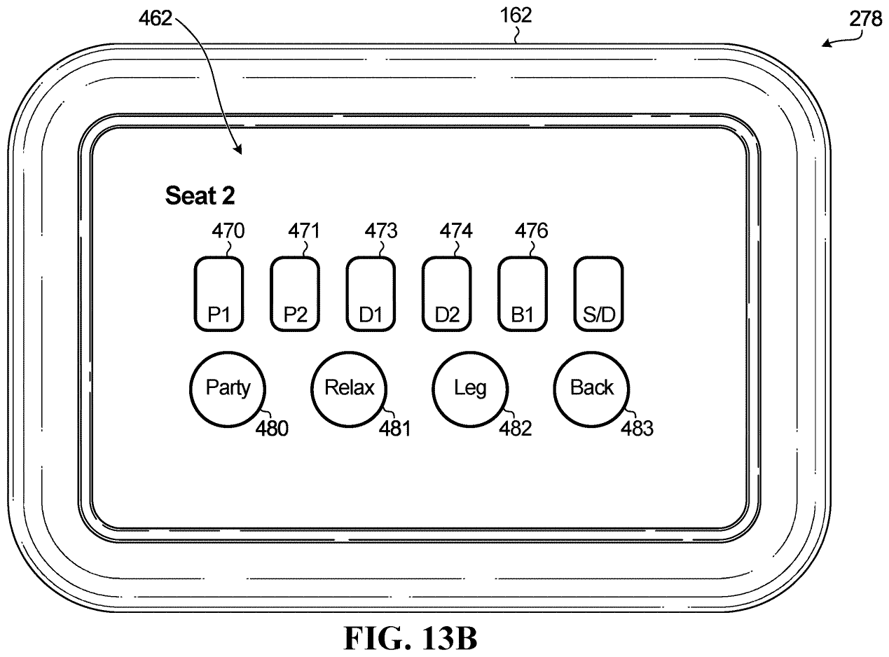

For example, in embodiments where the control panel 162 comprises the assembly 374, where the user interacts with the first selectable portion 380 of the selectable visual representation 381 shown in FIG. 8A (alternatively, interacting with the first selectable icon 390 in FIG. 8B, actuating the physical switch 400 to the first position 410 in FIG. 9A, interacting with the first key 420 in FIG. 9B, interacting with the first selectable option 430 in FIG. 9C, interacting with the first key 490 in FIG. 9D, interacting with the first selectable portion 380′in FIG. 11A or interacting with the first selectable icon 390′in FIG. 11B) to select the first seating area 130, the adapt user interface process 600 may direct the controller 160 and/or the control panel 162 to adapt the GUI to display at least one first seating area specific menu 460 (shown in FIG. 13A). The first seating area specific menu 460 may display selectable options associated with the first set of bathing unit components mapped to the first seating area 130 (e.g., one or more of the second pump 172, the second diverter valve 182, the first air blower 190, the first set of lights 200, the fourth set of lights 206, the first set of speakers 210 and the first display screen 220 in the embodiment shown in FIGS. 1 and 2). In the embodiment shown in FIG. 13A, the first seating area specific menu 460 does not show any selectable options associated with another set of bathing unit components not mapped to the first seating area 130; in other embodiments, selectable options associated with another set of bathing unit components may be greyed out or otherwise de-emphasized. Further, in the embodiment shown in FIG. 13A, the first seating area specific menu 460 may present a set of user selectable options including: at least one user selectable option 471 for controlling different operational settings of the second pump 172 (e.g., to operate in one or more of the “on” mode, “off” mode, “low” mode, “standard” mode and “high” mode, as retrieved from the operational settings data store 304); at least one user selectable option 474 for controlling different operational settings of the second diverter valve 182 (e.g., to position in different positions to direct flow of the water 108 towards or away from the inlet 112 associated with the first seating area 130); at least one user selectable option 476 for controlling the first air blower 190 (e.g., to operate in one or more of the “on” mode, “off” mode, “low” mode, “standard” mode and “high” mode, as retrieved from the operational settings data store 304); and similar user selectable options for controlling the first set of lights 200, the fourth set of lights 206, the first set of speakers 210 and the first display screen 220. Selection of a selectable option of the first seating area specific menu 460 may then cause the controller 160 and/or the control panel 162 to display another more granular menu for controlling operation of the bathing unit component corresponding to the selected selectable option and/or generate command signals for controlling the operational settings of the bathing unit component corresponding to the selected selectable option (e.g., by using the operate bathing unit components process 550 described above).

In contrast, in embodiments where the user interacts with the second selectable portion 382 of the selectable visual representation 381 shown in FIG. 8A (alternatively, by interacting with the second selectable icon 392 in FIG. 8B, actuating the physical switch 400 to the second position 412 in FIG. 9A, interacting with the second key 422 in FIG. 9B, interacting with the second selectable option 432 in FIG. 9C, interacting with the second key 492 in FIG. 9D, interacting with the second selectable portion 382′in FIG. 11A or interacting with the second selectable icon 392′in FIG. 11B) to select the second seating area 132, the adapt user interface process 600 may direct the controller 160 and/or the control panel 162 to adapt the GUI to display at least one second seat specific menu 462 (shown in FIG. 13B). The second seating area specific menu 462 may display selectable options associated with the second set of bathing unit components mapped to the second seating area 132 (e.g., one or more of the first pump 170, the second pump 172, the first diverter valve 180, the second diverter valve 182, the first air blower 190, the first set of lights 200, the fourth set of lights 206, the first set of speakers 210 and the first display screen 220 in the embodiment shown in FIGS. 1 and 2). In the embodiment shown in FIG. 13B, the second seating area specific menu 462 may present a set of user selectable options including: at least one user selectable option 470 for controlling the operational settings of the first pump 170, the at least one user selectable option 471 for controlling the operational settings of the second pump 172; at least one user selectable option 473 for controlling different operational settings of the first diverter valve 180; the at least one user selectable options 474 for controlling different operational settings of the second diverter valve 182; the at least one user selectable option 476 for controlling the first air blower 190; and user selectable options for controlling the first set of lights 200, the fourth set of lights 206, the first set of speakers 210 and the first display screen 220. Selection of a selectable option of the second seating area specific menu 462 may then cause the controller 160 and/or the control panel 162 to display another more granular menu for controlling operation of the bathing unit component corresponding to the selected selectable option and/or generate command signals for controlling the operational settings of the bathing unit component corresponding to the selected selectable option (e.g., by using the operate bathing unit components process 550 described above).

As described above, two seating areas of the two or more seating areas 131 may include at least one common bathing unit component which is included in both the sets of bathing unit components mapped to the seating areas. For example, one or more of the second pump 170, the second diverter valve 182, the first air blower 190, the fourth of lights 206, the first set of speakers 210 and the first display screen 220 may be common to both the first set of bathing unit components mapped to the first seating area 130 and the second set of bathing unit components mapped to the second seating area 132. The corresponding first and second seating area specific menus 460 and 462 may display the user selectable options which direct the operation of the common bathing unit component towards the corresponding first and second seating areas 130 and 132. For example, in response to the user selecting the first seating area 130, the user interface codes 301 may direct the controller 160 and/or the control panel 162 to display the user selectable option 474 for the second diverter valve 182 as an option to select the “first” position (e.g., directed to the first seating area 130); in contrast, in response to the user selecting the second seating area 132, the user interface codes 301 may direct the controller 160 and/or the control panel 162 to display the user selectable option 474 for the second diverter valve 182 as an option to select the “second” position (e.g., directed to the second seating area 132).

Two seating areas of the two or more seating areas 131 may include at least one non-common bathing unit component is included in one of the sets of bathing unit components mapped to one of the seating areas, but not in the other of the sets of bathing unit components mapped to the other of the seating areas. User selectable options associated with bathing unit components absent from the set of bathing unit components mapped to a particular seating area may be absent, disabled or otherwise de-emphasized from the seating area specific menu generated for that particular seating area. For example, the first pump 170 and the first diverter valve 180 are present in the second set of bathing unit components mapped to the second seating area 132, but are not present in the first set of bathing unit components mapped to the first seating area 130. The at least one user selectable option 470 and 473 corresponding to the first pump 170 and the first diverter valve 180 may be present in the second seating area specific menu 462 but absent from the first seating area specific menu 460. This can prevent a user from operating bathing unit components which are not mapped to the seating area selected by the user, and may allow different user to enjoy different operational settings and different spa experiences in their seating area without significantly affecting a user in another seating area.

In some embodiments, a seating area specific menu displayed after user selection of a particular seating area may further display selectable options for a particular spa experience (e.g., retrieved from the spa experience data store 306) to be implemented at the selected seating area.

For example, in embodiments where the user selects the first seating area 130, referring back to the first seating area specific menu 460 shown in FIG. 13A, the adapt user interface process 600 may direct the controller 160 and/or the control panel 162 to adapt the GUI to display a set of spa experience selectable options including: a selectable option 480 for selecting a “party” experience; a selectable option 481 for selecting a “relaxation” experience; a selectable option 482 for selecting a “back massage” experience; and a selectable option 483 for selecting a “leg massage” experience. In other embodiments, there may be additional, alternative or fewer spa experiences, including spa experiences which are modified/customized by a user as described above. Selection of a selectable option from the first seating area specific menu 460 may cause the controller 160 and/or the control panel 162 to generate command signals for controlling the operational settings of the first set of bathing unit components in order to implement the spa experience corresponding to the selected selectable option at the first seating area 130 (e.g., by using the operate bathing unit components process 550 described above).

Similarly, in embodiments where the user selects the second seating area 132, referring back to the second seating area specific menu 462 shown in FIG. 13B, the adapt user interface process 600 may direct the controller 160 and/or the control panel 162 to adapt the GUI to display the same set of spa experience selectable options (as the first seating area specific menu 460) including: the selectable option 480 for selecting the “party” experience; the selectable option 481 for selecting the “relaxation” experience; the selectable option 482 for selecting the “back massage” experience; and the selectable option 483 for selecting the “leg massage” experience. However, selection of a selectable option from the second seating area specific menu 462 may cause the controller 160 and/or the control panel 162 to generate command signals for controlling the operational settings of the second set of bathing unit components in order to implement the spa experience corresponding to the selected selectable option at the second seating area 132 (e.g., by using the operate bathing unit components process 550 described above).

In some embodiments, the selectable options displayed on a seat specific menu (e.g., the seating area specific menus 460 and 462) may be customized based on an identity of the user interacting with the least one user interface 278 to select a particular seating area. For example, the controller 160 and/or the control panel 162 may receive a user identification signal (e.g., from the user device 167, from the user logging into the control panel 162, and/or from a wearable user device associated with the user) conveying user identification information corresponding to the user providing the selection of the particular seating area and/or selection of a selectable option displayed on the seat specific menu. The controller 160 and/or the control panel 162 may then retrieve user preference information associated with the user identification information from the user preference data store 308 at least in part by processing the user identification information. For example, the user identification information may comprise a user_ID; the adapt user interface process 600 may direct the controller 160 and/or the control panel 162 to retrieve entries associated with that user_ID from one or more of the user preference data store 308, the spa experience data store 306, the operational settings data store 304 and/or the seating area data store 300 in order to retrieve user preference information. The user selectable options generated on the seat specific menu may then be customized based on the retrieved user preference information.

For example, if a particular first user (e.g., John associated with the entry 360 having the user_ID “John” in the user preference data store 308) selects the first seating area 130, and the retrieved user preference information associated with the first user indicates that the first user prefers the “party” experience at the first seating area 130 (e.g., a “party” experience from the spa experience data store 306 associated with the user_ID “John” and the seating_ID “seat1”, shown in FIG. 5A), the adapt user interface process 600 may direct the controller 160 and/or the control panel 162 to emphasize the selectable option 480 associated with the “party” experience on the first seating area specific menu 460 (e.g., larger, colored, bolded, moving, etc.), while deemphasizing the selection options 481, 482, and 482 associated with the other spa experiences (e.g., smaller, black and white or greyed out, etc.), when displaying the first seating area specific menu 460. Additionally or alternatively, if the retrieved user preference information associated with the first user indicates that the first user often adjusts the speed of the second pump 172 while at the first seating area 130, the adapt user interface process 600 may direct the controller 160 and/or the control panel 162 to emphasize the user selectable option 471 associated with the second pump 172, while deemphasizing the user selectable options associated with other bathing unit components in the first set of bathing unit components, when displaying the first seating area specific menu 460.

In contrast, if the same first user selects the second seating area 132, and the retrieved user preference information indicates that the first user prefers the “back massage” experience at the second seating area 132 (e.g., a “back massage” experience from the spa experience data store 306 associated with the user_ID “John” and the seat_ID “seat2”, shown in FIG. 5B), the adapt user interface process 600 may direct the controller 160 and/or the control panel 162 to emphasize the selectable option 482 associated with the “back massage” experience while deemphasizing the selectable options 480, 481 and 483 associated with the other spa experiences, when displaying the second seating area specific menu 462.

In contrast, if a particular second user (e.g., Jane associated with the entry 361 having the user_ID “Jane” in the user preference data store 308) selects the first seating area 130, and the retrieved user preference information associated with the second user indicates that the second user prefers the “relaxation” experience at the first seating area 130 (e.g., a “relaxation” experience from the spa experience data store 306 associated with the user_ID “Jane” and the seating_ID “seat1”, shown in FIG. 5A), the adapt user interface process 600 may direct the controller 160 and/or the control panel 162 to emphasize the selectable option 481 associated with the “relaxation” experience while deemphasizing the selectable options 480, 482 and 483 associated with the other spa experiences, when displaying the first seating area specific menu 460. Additionally or alternatively, if the retrieved user preference information associated with the first user indicates that the first user often adjusts the audio streamed or projected by the first set of speakers 210 while at the first seating area 130, the adapt user interface process 600 may direct the controller 160 and/or the control panel 162 to emphasize the selectable option associated with the first set of speakers, while deemphasizing the selectable options associated with other bathing unit components in the first set of bathing unit components, when displaying the first seating area specific menu 460.

### Conclusion

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about”, “substantially” or “approximately” shall generally mean within the error margin generally accepted in the art. Hence, numerical quantities given herein generally include such error margin such that the terms “around”, “about” “substantially” or “approximately” can be inferred if not expressly stated. For greater clarity, unless otherwise explicitly stated, the terms “around”, “about”, “substantially” and “approximately” means a proportion of at least about 60%, or at least about 70% or at least about 80%, or at least about 90%, at least about 95%, at least about 97% or at least about 99% or more, or any integer between 70% and 100%.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Unless otherwise defined, all technical and scientific terms used herein have the same meaning as commonly understood by one of ordinary skill in the art to which this invention pertains. In the case of conflict, the present document, including definitions will control.

Although various embodiments of the invention have been described and illustrated, it will be apparent to those skilled in the art in light of the present description that numerous modifications and variations can be made. The scope of the invention is defined more particularly in the appended claims.

1. A system for controlling a bathing unit system including a receptacle with two or more seating areas and a plurality of bathing unit components, the system comprising:
a) a user interface presenting user selectable options corresponding to seating areas amongst the two or more seating areas, the user selectable options allowing a user to independently select a specific seating area of the two or more seating areas; and
b) at least one processor in communication with the user interface and configured to:
i) receive a user input signal conveying a user selection of a first seating area of the two or more seating areas; and
ii) in response to the user selection of the first seating area of the two or more seating areas, control at least one of:
A. operational settings of a first set of the plurality of bathing unit components, the first set of the plurality of bathing unit components being mapped to the first seating area; and
B. a specific spa experience in connection with the first seating area at least in part by controlling the first set of the plurality of bathing unit components.

2. The system of claim 1, wherein in response to the user selection of the first seating area, said at least one processor being further configured to:
a) access a computer readable memory storing seating area specific information, said seating area specific information mapping each of the two or more seating areas to respective sets of bathing unit components in the plurality of bathing unit components; and
b) process the seating area specific information and the first seating area to derive the first set of the plurality of bathing unit components mapped to the first seating area.

3. The system of claim 2, further comprising the computer readable memory storing seating area specific information, said computer readable memory being in communication with said at least one processor.

4. (canceled)

5. The system of claim 1, further comprising a display screen, wherein the user interface comprises a graphical user interface (GUI) displayed on the display screen.

6. The system of claim 5, wherein the at least one processor is configured to generate the GUI to present the user selectable options as at least one of:
a) user selectable portions of a visual representation of the receptacle showing each seating area of the two or more seating areas spatially oriented relative to other seating areas of the two or more seating areas; and
b) user selectable icons corresponding to respective seating areas of the two or more seating areas.

7. The system of claim 1, wherein the user interface comprises two or more physical keys corresponding to the user selectable options.

8. The system of claim 7, wherein the user interface further comprises a visual representation of the receptacle showing each seating area of the two or more seating areas spatially oriented relative to other seating areas of the two or more seating areas.

9. The system of claim 5, wherein the at least one processor is further configured to, in response to the user selection of the first seating area, adapt the GUI to present a first set of user selectable options customized to the first seating area, the first set of user selectable options selectable by the user to generate command signals for controlling at least one of:
a) the operational settings of the first set of the plurality of bathing unit components; and
b) the specific spa experience in connection with the first seating area.

10. The system of claim 9, wherein the at least one processor is further configured to, in response to a user selection of a second seating area of the two or more seating areas, adapt the GUI to present a second set of user selectable options customized to the second seating area, the second set of user selectable options selectable by the user to generate command signals for controlling at least one of:
a) operational settings of a second set of the plurality of bathing unit components, the second set of the plurality of bathing unit components being mapped to the second seating area; and
b) a specific spa experience in connection with the second seating area at least in part by controlling the second set of the plurality of bathing unit components.

11. The system of claim 10, wherein the first set of user selectable options and the second set of user selectable options are different.

12. The system of claim 1, wherein the at least one processor is further configured to, in response to a user selection of a second seating area of the two or more seating areas, control at least one of:
a) operational settings of a second set of the plurality of bathing unit components, the second set of the plurality of bathing unit components being mapped to the second seating area; and
b) a specific spa experience in connection with the second seating area at least in part by controlling the second set of the plurality of bathing unit components.

13. The system of claim 1, wherein the at least one processor is further configured to, after controlling the first set of the plurality of bathing unit components, control at least one of:
a) operational settings for a second set of the plurality of bathing unit components, the second set of the plurality of bathing unit components being mapped to a second seating area of the two or more seating areas; and
b) a specific spa experience in connection with the second seating area at least in part by controlling the second set of the plurality of bathing unit components.

14. The system of claim 1, wherein the at least one processor is further configured to, concurrently with controlling the first set of the plurality of bathing unit components, control at least one of:
a) operational settings for a second set of the plurality of bathing unit components, the second set of the plurality of bathing unit components being mapped to a second seating area of the two or more seating areas; and
b) a specific spa experience in connection with the second seating area at least in part by controlling the second set of the plurality of bathing unit components.

15. The system of claim 10, wherein the first set of the plurality of bathing unit components and the second set of the plurality of bathing unit components include at least one common bathing unit component.

16. The system of claim 15, wherein the operational settings for the first set of the plurality of bathing unit components direct operation of the at least one common bathing unit component towards the first seating area and wherein the operational settings for the second set of the plurality of bathing unit components direct the operation of the at least one common bathing unit component towards the second seating area.

17. (canceled)

18. The system of claim 10, wherein the first set of the plurality of bathing unit components comprises at least one bathing unit component that is absent from the second set of the plurality of bathing unit components.

19. The system of claim 1, wherein the at least one processor is further configured to:
a) receive a user identification signal conveying user identification information corresponding to the user providing the user selection; and
b) retrieve user preference information from a memory in communication with the at least one processor at least in part by processing the user identification information, wherein the at least one processor is configured to control the first set of the plurality of bathing unit components at least in part by processing the retrieved user preference information.

20. (canceled)

21. The system of claim 1, wherein the user input signal conveying the user selection of the first seating area comprises at least one of:
a) an input signal generated by the user interface in response to the user selecting the first seating area using the user selectable options presented by the user interface;
b) an input signal generated by an occupancy sensor conveying that the user is occupying the first seating area in the receptacle; and
c) an input signal generated by a sensor detecting a user interaction selecting the first seating area.

22. The system of claim 21, wherein:
a) the sensor detecting the user interaction comprises at least one microphone and the user interaction comprises a voice command conveying the first seating area; and/or
b) the sensor detecting the user interaction comprises at least one camera and the user interaction comprises a movement command conveying the first seating area.

23. The system of claim 1, wherein the at least one processor is embodied in at least one of a control panel and a controller, wherein the control panel comprises at least one of a topside control panel and a personal communication device and wherein the controller comprises at least one of a local bathing unit controller and a remote server.

24. (canceled)

25. The system of claim 23, wherein the personal communication device is at least one of a smart phone, a wearable device, a tablet and a personal computer.

26. (canceled)

27. A computer-implemented method for controlling a bathing unit system including a receptacle with two or more seating areas, a plurality of bathing unit components and a user interface presenting user selectable options corresponding to seating areas amongst the two or more seating areas, the user selectable options allowing a user to independently select a specific seating area of the two or more seating areas, the computer-implemented method comprising:
a) receive a user input signal conveying a user selection of a first seating area of the two or more seating areas; and
b) in response to the user selection of the first seating area of the two or more seating areas, controlling at least one of:
i) operational settings of a first set of the plurality of bathing unit components, the first set of the plurality of bathing unit components being mapped to the first seating area; and
ii) a specific spa experience in connection with the first seating area at least in part by controlling the operational settings of the first set of the plurality of bathing unit components.

28. The computer-implemented method of claim 27, comprising, in response to the user selection of the first seating area:
a) accessing a computer readable memory storing seating area specific information, said seating area specific information mapping each of the two or more seating areas in the receptacle to respective sets of bathing unit components in the plurality of bathing unit components; and
b) processing the seating area specific information and the first seating area to derive the first set of the plurality of bathing unit components mapped to the first seating area.

29. The computer-implemented method of claim 27, wherein the user interface comprises a graphical user interface (GUI) presented on a display screen and wherein the GUI presents the user selectable options as at least one of:
a) user selectable portions of a visual representation of the receptacle showing each seating area of the two or more seating areas spatially oriented relative to other seating areas of the two or more seating areas; and
b) user selectable icons corresponding to respective seating areas of the two or more seating areas.

30. (canceled)

31. The computer-implemented method of claim 29, further comprising, in response to the user selection of the first seating area, adapting the GUI to present a first set of user selectable options customized to the first seating area, the first set of user selectable options selectable by the user to generate command signals for controlling at least one of:
a) the operational settings of the first set of the plurality of bathing unit components; and
b) the specific spa experience in connection with the first seating area.

32. The computer-implemented method of claim 31, further comprising, in response to a user selection of a second seating area of the two or more seating areas, adapting the GUI to present a second set of user selectable options customized to the second seating area, the second set of user selectable options selectable by the user to generate command signals for controlling at least one of:
a) operational settings of a second set of the plurality of bathing unit components, the second set of the plurality of bathing unit components being mapped to the second seating area; and
b) a specific spa experience in connection with the second seating area at least in part by controlling the second set of the plurality of bathing unit components.

33. (canceled)

34. (canceled)

35. (canceled)

36. (canceled)

37. (canceled)

38. The computer-implemented method of claim 32, wherein the first set of the plurality of bathing unit components comprises at least one bathing unit component that is absent from the second set of the plurality of bathing unit components.

39. The computer-implemented method of claim 27, further comprising:
a) receiving a user identification signal conveying user identification information corresponding to the user providing the user selection; and
b) receiving user preference information at least in part by processing the user identification information, wherein controlling the operational settings of the first set of the plurality of bathing unit components comprises controlling the operational settings of the first set of the plurality of bathing unit components at least in part by processing the retrieved user preference information.

40. (canceled)

41. The computer-implemented method of claim 27, wherein the user input signal comprises at least one of:
a) an input signal generated by the user interface in response to the user selecting the first seating area using the user selectable options presented by the user interface;
b) an input signal generated by an occupancy sensor conveying that the user is occupying the first seating area in the receptacle; and
c) an input signal generated by a sensor detecting a user interaction selecting the first seating area.

42. (canceled)

43. (canceled)

44. A control panel for a bathing unit system including a receptacle with two or more seating areas and a plurality of bathing unit components, the control panel comprising:
a) a display screen; and
b) one or more processors in communication with the display screen, the one or more processors configured for:
i) displaying a graphical user interface (GUI) on the display screen presenting user selectable options corresponding to seating areas amongst the two or more seating areas, the user selectable options allowing a user to independently select a specific seating area of the two or more seating areas;
ii) receiving a user input signal conveying a user selection of a first seating area of the two or more seating areas; and
iii) in response to the user selection of the first seating area of the two or more seating areas, adapting the GUI to present a first set of user selectable options customized to the first seating area, the first set of user selectable options selectable the user to generate command signals for controlling at least one of:
A. operational settings of a first set of the plurality of bathing unit components, the first set of the plurality of bathing unit components being mapped to the first seating area; and
B. a specific spa experience in connection with the first seating area at least in part by controlling the first set of the plurality of bathing unit components.

45. The control panel of claim 44, wherein in response to the user selection of the first seating area, the one or more processors being further configured for:
a) accessing a computer readable memory storing seating area specific information, said seating area specific information mapping each of the two or more seating areas in the receptacle to respective sets of bathing unit components in the plurality of bathing unit components; and
b) processing the seating area specific information and the first seating area to derive the first set of the plurality of bathing unit components mapped to the first seating area.

46. (canceled)

47. The control panel of claim 44, wherein the one or more processors are configured for displaying the GUI such that the user selectable options are presented as at least one of:
a) user selectable portions of a visual representation of the receptacle showing each seating area of the two or more seating areas spatially oriented relative to other seating areas of the two or more seating area; and
b) user selectable icons corresponding to respective seating areas of the two or more seating areas.

48. The control panel of claim 44, wherein the one or more processors are further configured for, in response to user selection of a second seating area of the two or more seating areas, adapting the GUI to present a second set of user selectable options customized to the second seating area, the second set of user selectable options selectable by the user to generate command signals for controlling at least one of:
a) operational settings of a second set of the plurality of bathing unit components, the second set of the plurality of bathing unit components being mapped to the second seating area; and
b) a specific spa experience in connection with the second seating area at least in part by controlling the second set of the plurality of bathing unit components.

49. The control panel of claim 48, wherein the first set of the plurality of bathing unit components comprises at least one bathing unit component that is absent from the second set of the plurality of bathing unit components.

50. The control panel of claim 44, wherein the one or more processors are further configured for:
a) receiving a user identification signal conveying user identification information corresponding to the user providing the user selection; and
b) retrieve user preference information from a memory in communication with the one or more processors at least in part by processing the user identification information, wherein the first set of user selectable options are further customized based on the retrieved user preference information.

51. The control panel of claim 50, wherein the user identification signal is received from a personal communication device, wherein the personal communication device is one of a smart phone, a wearable device, a tablet and a personal computer.

52. The control panel of claim 44, wherein the control panel is embodied in at least one of a topside control panel and a personal communication device.

53. (canceled)

54. (canceled)

55. A system for controlling a bathing unit system including a receptacle with two or more seating areas and a plurality of bathing unit components, the system comprising:
a) the control panel of claim 44; and
b) a bathing unit controller in communication with the control panel and comprising one or more controller processors, the one or more controller processors configured for:
i) receiving the command signals from the control panel; and
ii) processing the command signals and controlling at least one of:
A. the operational settings of the first set of the plurality of bathing unit components based at least in part on the command signals; and
B. the specific spa experience in connection with the first seating area based at least in part on the command signals.

56. (canceled)

57. (canceled)

58. (canceled)

59. (canceled)

60. (canceled)

61. A control panel for a bathing unit system including a receptacle with two or more seating areas and a plurality of bathing unit components, the control panel including user selectable options selectable by a user to independently select a specific seating area of the two or more seating areas, wherein the control panel is configured for:
a) receiving a user input signal conveying a user selection of a first seating area of the two or more seating areas; and
b) in response to the user selection of the first seating area of the two or more seating areas, generating command signals for controlling at least one of:
i) operational settings for a first set of the plurality of bathing unit components, the first set of the plurality of bathing unit components being mapped to the first seating area; and
ii) a specific spa experience in connection with the first seating area at least in part by controlling the first set of the plurality of bathing unit components.

62. The control panel of claim 61, comprising, in response to the user selection of the first seating area:
a) accessing a computer readable memory storing seating area specific information, said seating area specific information mapping each of the two or more seating areas in the receptacle to respective sets of bathing unit components in the plurality of bathing unit components;
b) processing the seating area specific information and the first seating area to derive the first set of the plurality of bathing unit components mapped to the first seating area.

63. The control panel of claim 61, wherein the control panel comprises a display screen displaying a graphical user interface (GUI) presenting the user selectable options as at least one of:
a) a visual representation of the receptacle showing each seating area of the two or more seating areas spatially oriented relative to other seating areas of the two or more seating areas; and
b) user selectable icons corresponding to respective seating areas of the two or more seating areas.

64. The control panel of claim 61, wherein the control panel comprises two or more physical keys corresponding to the user selectable options.

65. (canceled)

66. (canceled)

67. (canceled)

68. (canceled)

69. A system for controlling a bathing unit system including a receptacle with two or more seating areas and a plurality of bathing unit components, the system comprising:
a) the control panel of claim 61; and
b) a controller in communication with the control panel, wherein the controller is configured for:
i) receiving the command signals from the control panel; and
ii) processing the command signals and controlling at least one of:
A. the operational settings of the first set of the plurality of bathing unit components based at least in part on the command signals; and
B. the specific spa experience in connection with the first seating area based at least in part on the command signals.

70. A controller for controlling a bathing unit system including a receptacle with two or more seating areas, a plurality of bathing unit components and a user interface including user selectable options corresponding to seating areas amongst the two or more seating areas, the user selectable options allowing a user to independently select a specific seating area of the two or more seating areas, the controller configured to:
a) receive a user input signal conveying user selection of a first seating area of the two or more seating areas; and
b) in response to the user selection of the first seating area, control at least one of:
i) operational settings of a first set of the plurality of bathing unit components, the first set of the plurality of bathing unit components being mapped to the first seating area; and
ii) a specific spa experience in connection with the first seating area at least in part by controlling the operational settings of the first set of the plurality of bathing unit components.

71. (canceled)

72. (canceled)

73. (canceled)

74. (canceled)

75. (canceled)
